(19) United States
(12) Patent Application Publication
(10) Pub. No.: US 2026/0268320 A1
(43) Pub. Date: Sep. 10, 2026

(54) Deterministic Supply-Indexed Adaptive State-Transition Control Architecture for Distributed Execution Environments

(71) Applicant: Frontage Road Holdings, LLC, Wilmington, DE (US)

(72) Inventors: Erik Lewis, Lafayette, CA (US); Josh Williams, Sacramento, CA (US); Neelesh Tiruviluamala, Palo Alto, CA (US); Alexander Port, Burbank, CA (US); Harrison Algra, Valencia, CA (US); Jacob Sundstrom, San Diego, CA (US); Tobin Chodos, Encinitas, CA (US); Miguel Ottina, Rivadavia, Mendoza (AR)

(21) Appl. No.: 19/546,030

(22) Filed: Feb. 20, 2026

Related U.S. Application Data
(60) Provisional application No. 63/761,852, filed on Feb. 21, 2025.

(51) Int. Cl. G06Q 20/38; G06Q 20/40

(52) U.S. Cl. CPC G06Q 20/389; G06Q 20/4016

(57) ABSTRACT

The disclosure provides an adaptive mechanism for controlling how digital state variables evolve within a distributed computing environment. In an example, the system maintains a cumulative quantity value stored in persistent, consensus-replicated storage. This value determines a dynamically adjustable linear response function that governs how subsequent state changes are calculated. When an authenticated instruction modifies the cumulative quantity, the system computes a transition amount using a quadratic accumulation process and then updates the response function to remain continuous and stable. The mechanism may maintain an aggregate stored value that increases under repeated state movements, preventing costless oscillation. The architecture operates deterministically, recalibrating from current state without, for example, reliance on external data. The result may provide an efficient, predictable, and scalable approach for managing adaptive state transitions within distributed deterministic systems while limiting value extractable from transaction reordering.

### RELATED APPLICATION

This application claims the benefit of U.S. Provisional Application No. 63/761,852, filed on Feb. 21, 2025. The entire teachings of the above application are incorporated herein by reference.

### BACKGROUND

A blockchain system may be implemented as a distributed, append-only state-replication architecture in which a network of independently operating nodes maintains a shared ledger by agreeing on an ordered sequence of state transitions. The blockchain system may function as a deterministic state machine, where each new state is derived by applying validated inputs to a prior state under a formally defined transition function. Cryptographic hashing may be used to link blocks of transactions into an immutable chain providing historical integrity. A consensus mechanism, for example, Proof of Work, Proof of Stake, or Byzantine Fault Tolerant voting, can determine canonical transaction ordering and resolve conflicts among competing state histories. An execution environment, which may follow a UTXO model, an account-based model, or a programmable virtual machine architecture, may be provided to process transactions and enforce system rules deterministically across all nodes.

Blockchain systems may vary in structure and governance. Public or permissionless systems can allow unrestricted participation in validation and transaction submission, emphasizing decentralization and censorship resistance. Permissioned and private variants restrict validator participation, often optimizing for throughput and deterministic finality in enterprise or consortium environments. Across variations, typically the unifying characteristic remains a cryptographically secured, consensus-driven, distributed state machine designed to maintain synchronized system state across untrusted nodes.

In a blockchain system, a transaction is typically a signed instruction that proposes a state transition within the replicated state machine. A transaction, for example, may be configured to specify input parameters, references prior state, and includes a cryptographic signature that authenticates the originator under asymmetric key infrastructure. When validated and included in an ordered block, the transaction can be deterministically executed by all participating nodes, resulting in an updated global state. Transactions may represent simple state reassignments, the invocation of programmable logic, the creation or destruction of state entries, or the modification of stored data. Because execution is deterministic, identical transaction sequences applied to identical prior states yield identical resulting states across all nodes.

Tokens, for example, may be implemented as structured state entries within the blockchain's global state that represent units of assignable or transferable rights encoded in software. Tokens are typically programmable data objects whose ownership and transferability are usually enforced by protocol rules. In UTXO-based systems, for example, tokens may be represented as unspent outputs that can be consumed and reassigned. In account-based systems, for example, tokens may be recorded with state mappings associated with public key addresses. Token representations may include metadata, programmable constraints, supply control logic, or object-based ownership models. Conceptually, a token may be a digitally scarce state variable governed by consensus rules, and a transaction may be the mechanism through which the ownership or configuration of that state variable is altered in a cryptographically verifiable and globally synchronized manner.

On-chain exchange, for example, may provide the direct, protocol-level transformation of one state representation into another within a blockchain's deterministic execution environment. Rather than relying on an external coordinator or off-chain matching process, the transformation is typically governed by smart contract logic embedded in the distributed state machine. When a node submits a transaction, it typically functions as a signed instruction requesting a specific state transition—such as converting one digital unit type into another—under predefined mathematical or programmatic rules. Once validated and included in a block, the transaction may be executed atomically across all nodes, updating balances, parameters, or stored objects in a synchronized manner. In this example model, exchange may be a constrained state transformation enforced by consensus, and transactions are cryptographically authenticated inputs that trigger those transformations within the shared ledger.

### SUMMARY

Conventional on-chain exchange mechanisms algorithmically map input quantities to output quantities without relying on centralized coordination or discrete order matching. Typical designs employ invariant-based mathematical formulations, such as multiplicative constant-product relationships, to preserve a conserved constraint between paired state variables within a distributed ledger environment. These mechanisms enable continuous, autonomous value transformation typically governed entirely, for example, by embedded mathematical rules, eliminating external schedulers or negotiated counterpart discovery. Such on-chain exchange mechanisms typically rely on throughput reserve pools, and lack computational efficiency and system responsiveness under dynamic input conditions.

In an example embodiment, a blockchain virtual machine implements a smart contract system configured to execute an adaptive state-transition bonding curve smart contract system. The blockchain virtual machine may execute a computational model—the deterministic adaptive state-transition bonding curve model—in a smart contract system in the blockchain network. In one preferred example, the deterministic adaptive state-transition bonding curve model may be configured as an Adjusting Linear Token Bonding Curve (ALTBC).

The deterministic adaptive state-transition bonding curve model can provide, for example, technical improvements over existing systems, such as invariant-based smart contract systems, by replacing iterative invariant enforcement and external dependencies with a deterministic, closed-form slope update that executes in constant time per blockchain transaction. Because a value function, for example, may computed from a simple linear function whose parameters update directly as a function of current supply (rather than recalculating multi-asset reserve ratios or relying on oracle feeds), the contract logic of the deterministic adaptive state-transition bonding curve model maybe computationally lighter and avoid oracle latency, reducing on-chain processing overhead and attack surface.

In an embodiment, the deterministic adaptive state-transition bonding curve model's path-independent slope field means value function impact may, for example, be advantageously derived from supply alone, eliminating the need for continuous rebalancing or active state transition capacity management as required in concentrated-throughput reserve systems.

Because a deterministic adaptive state-transition bonding curve smart contract system is configured in some implementations to avoid initial two-sided capital provisioning and collateral accruing algorithmically with each transaction, the deterministic adaptive state-transition bonding curve smart contract protocol can scale without depending on external throughput reserve depth, reducing coordination complexity and resource intensive (gas-intensive) state transition capacity management operations. In this way, the bounded maximal retractable value (MEV) properties may further improve system efficiency by limiting adversarial congestion behaviors that can otherwise increase network load and transaction contention. Collectively, these example features position state-transition bonding curve smart contract protocol as a more computationally streamlined and operationally scalable architecture compared to traditional systems that rely on static invariants, external arbitrage alignment, and active state transition capacity reconfiguration.

In some example embodiments, a deterministic adaptive state-transition bonding curve smart contract system is disclosed. The deterministic adaptive state-transition bonding curve smart contract system may be implemented within a distributed execution environment, such as a consensus-replicated ledger system. The mechanism, for example, may improve computational efficiency, scalability, and adversarial robustness in distributed state machines by introducing a supply-indexed adaptive slope architecture with quadratic accumulation-based transition accounting.

In some example embodiments, the deterministic adaptive state-transition bonding curve smart contract system maintains a cumulative quantity state variable representing the current position of the mechanism within a bounded state domain. This variable serves as a control index that deterministically parameterizes system responsiveness. An adaptive linear evaluation function is maintained comprising a slope parameter and an intercept parameter. The slope parameter is dynamically computed as an inverse function of the cumulative quantity state variable and a concentration constant. Because each cumulative quantity value uniquely determines a corresponding slope parameter, the mechanism achieves path independence of slope and eliminates dependence on historical sequencing beyond the current state value.

Upon receipt of an authenticated instruction modifying the cumulative quantity state variable, in example embodiments, the deterministic adaptive state-transition bonding curve smart contract system computes a transition delta using a quadratic accumulation function evaluated before and after the modification. The difference between these evaluations determines the state-transition magnitude. The cumulative quantity is updated, and both the slope and intercept parameters are recalculated. The intercept parameter is recomputed in a manner that preserves continuity of the evaluation function at the updated cumulative quantity, thereby preventing discontinuities or numerical instability during successive transitions.

In some embodiments, the deterministic adaptive state-transition bonding curve smart contract system may include an adaptive state reserve. An adaptive state reserve may be configured as a consensus-replicated, ledger-resident aggregate state register that accumulates and preserves the net effects of deterministic state transitions governed by an adaptive evaluation function.

The adaptive state reserve may be configured to store an aggregate value derived from a quadratic accumulation function evaluated across cumulative quantity transitions. It may be updated through authenticated state-modifying instructions executed within a distributed deterministic state machine. It may increase monotonically under cyclic excursions of the cumulative quantity state variable. It may serve as the backing accumulator that preserves historical transition contributions.

In some example embodiments, the adaptive slope architecture of the deterministic adaptive state-transition bonding curve smart contract system may help avoid having to solve coupled multi-variable invariant equations during state updates. Instead, for example, each transition may direct evaluation of a closed-form quadratic expression and deterministic recalculation of a slope parameter as a simple inverse function of a single scalar state variable. This can reduce computational complexity per transition and improve execution efficiency in virtual machine environments.

In some example embodiments, the slope of the deterministic adaptive state-transition bonding curve model may be uniquely indexed to the cumulative quantity state variable. Because slope is derived from present state and not from prior slope history, the system achieves path-independent recalibration. This reduces storage requirements and avoids recursive dependency chains, thereby improving determinism and simplifying verification.

In some example embodiments, the deterministic adaptive state-transition bonding curve smart contract system maintains an aggregate stored value derived from the quadratic accumulation function. This value is stored in consensus-replicated persistent storage and increases monotonically under cyclic excursions of the cumulative quantity variable. This monotonic accumulation property prevents neutral-cost oscillatory manipulation of the state variable and enhances stability of the distributed state machine.

In some example embodiments, the deterministic adaptive state-transition bonding curve smart contract system exhibits bounded adversarial extraction characteristics. When perturbation instructions are applied before and after a target instruction, the extractable value is finite and becomes negative beyond a threshold perturbation magnitude. This property limits value derivable from transaction reordering and improves resistance to adversarial ordering strategies without reliance on external enforcement mechanisms.

In some example embodiments, when a requested modification is partitioned into multiple smaller sequential modifications, the slope parameter is recalculated after each partition. As the number of partitions increases, system behavior converges to a continuous limiting curve composed of a rational component and a logarithmic component dependent on the cumulative quantity and concentration parameter. This convergence behavior provides predictable scaling characteristics under high-frequency or subdivided input patterns.

In some example embodiments, the deterministic adaptive state-transition bonding curve smart contract system enforces a strictly positive lower bound on the cumulative quantity state variable, preventing costless cyclic traversal of the state domain. Because all recalibration occurs exclusively in response to authenticated instructions and relies solely on consensus-replicated state, the mechanism operates without dependence on external data feeds or off-chain coordination.

In certain implementations, proportional ownership of accumulated system state of the deterministic adaptive state-transition bonding curve smart contract system may be represented by non-fungible digital objects that store an ownership amount and a last-claimed aggregate-state marker, enabling precise and duplication-resistant allocation of accumulated value.

In some example embodiments, the deterministic adaptive state-transition bonding curve smart contract system provides a supply-indexed adaptive state-evolution architecture that improves computational efficiency, determinism, numerical stability, adversarial resistance, and scalability in distributed deterministic state machines.

An example embodiment of the disclosure is directed to a computer-based system for providing dynamic computational value for digital asset transactions. A deterministic adaptive state-transition bonding curve smart contract system may include a computer network with multiple nodes. At least one node of the plurality of nodes may be configured to execute a decentralized adaptive state-transition bonding curve smart contract system. The decentralized adaptive state-transition bonding curve smart contract system deterministic adaptive state-transition bonding curve smart contract system may be configured to implement a deterministic adaptive state-transition bonding curve model. The deterministic adaptive state-transition bonding curve model may be configured to receive an indication of an asset transaction in a digital asset from a computing node. The asset transaction may include an amount of the digital asset. The deterministic adaptive state-transition bonding curve model may be further configured to identify a current asset value model associated with the digital asset. The deterministic adaptive state-transition bonding curve model may be further configured to, based on the amount and the current asset value model, dynamically generate an updated asset value model for the digital asset. The deterministic adaptive state-transition bonding curve model may be further configured to, using the updated asset value model, determine an asset value for the digital asset.

In an example embodiment, the decentralized adaptive state-transition bonding curve smart contract system may include a vector field parameter. The decentralized adaptive state-transition bonding curve smart contract system may be further configured to dynamically generate the updated asset value model by: (1) based on (i) the amount and (ii) a quantity parameter of the current asset value model, determining an updated quantity parameter of the updated asset value model; (2) based on (i) the updated quantity parameter, (ii) the vector field parameter, and (iii) a coefficient sensitivity parameter of the current asset value model, determining an updated first coefficient parameter of the updated asset value model; (3) based on (i) the updated quantity parameter, (ii) a first coefficient parameter of the current asset value model, (iii) the updated first coefficient parameter, and (iv) a second coefficient parameter of the current asset value model, determining an updated second coefficient parameter of the updated asset value model; and (4) based on (i) the updated quantity parameter, (ii) the updated first coefficient parameter, and (iii) the updated second coefficient parameter, determining the asset value for the digital asset.

According to an example embodiment, the decentralized adaptive state-transition bonding curve smart contract system may configure variables associated with digital assets. The asset variables may be: (i) a transfer of the amount of a first type of digital asset from the set of digital assets to the computing node, (ii) a transfer of the amount of the first type of digital asset from the computing node to the set of digital assets, (iii) a transfer of the amount of a second type of digital asset from the set of digital assets to the computing node, or (iv) a transfer of the amount of the second type of digital asset from the computing node to the set of digital assets.

In an example embodiment, the decentralized adaptive state-transition bonding curve smart contract system may include a vector field parameter. The decentralized adaptive state-transition bonding curve smart contract system may be further configured to receive an indication of a computational value increase from the computing node. The computational value increase may include a first amount of the digital asset and a second amount of a collateral asset. The decentralized adaptive state-transition bonding curve smart contract system may be further configured to, based on (i) the first amount, (ii) the second amount, (iii) a first coefficient parameter of the current asset value model, (iv) a second coefficient parameter of the current asset value model, (v) a quantity parameter of the current asset value model, (vi) a maximum quantity parameter of the current asset value model, (vii) a collateral amount parameter of the current asset value model, (viii) a virtual collateral amount parameter of the current asset value model, (ix) a minimum quantity parameter of the current asset value model, (x) a coefficient sensitivity parameter of the current asset value model, and (xi) a total generated assets parameter of the current asset value model, determine: (i) an updated quantity parameter, (ii) an updated maximum quantity parameter, (iii) an updated minimum quantity parameter, (iv) an updated coefficient sensitivity parameter, (v) an updated virtual collateral amount parameter, (vi) an updated total generated assets parameter, and (vii) a generated asset amount. The decentralized adaptive state-transition bonding curve smart contract system may be further configured to, based on (i) the vector field parameter, (ii) the updated quantity parameter, and (iii) the updated coefficient sensitivity parameter, determine an updated first coefficient parameter. The decentralized adaptive state-transition bonding curve smart contract system may be further configured to, based on (i) the first coefficient parameter, (ii) the updated first coefficient parameter, (iii) the updated quantity parameter, and (iv) the second coefficient parameter, determine an updated second coefficient parameter. The decentralized adaptive state-transition bonding curve smart contract system may be further configured to, based on (i) the updated quantity parameter, (ii) the updated first coefficient parameter, (iii) the updated second coefficient parameter, (iv) the updated minimum quantity parameter, (v) the updated coefficient sensitivity parameter, (vi) the updated virtual collateral amount parameter, and (vi) the updated total generated assets parameter, determine an updated yield value. The decentralized adaptive state-transition bonding curve smart contract system may be further configured to, based on (i) the generated asset amount and (ii) the updated yield value, generate a collateral token. The decentralized adaptive state-transition bonding curve smart contract system may be further configured to transfer the collateral token to the computing node.

According to an example embodiment, the decentralized adaptive state-transition bonding curve smart contract system may be further configured to receive an indication of (i) an interchange value and (ii) a computational value decrease from the computing node in the distributed network. The computational value decrease may include a token.

The token may include a token amount and a token value. The decentralized adaptive state-transition bonding curve smart contract system may be further configured to, based on (i) the interchange value and (ii) a total generated assets parameter of the current asset value model, determine an intermediate value.

The decentralized adaptive state-transition bonding curve smart contract system may be further configured to, based on (i) a quantity parameter of the current asset value model, (ii) a first coefficient parameter of the current asset value model, (iii) a second coefficient parameter of the current asset value model, (iv) a minimum quantity parameter of the current asset value model, (v) a coefficient sensitivity parameter of the current asset value model, (vi) a virtual collateral amount parameter of the current asset value model, and (vi) a total generated assets parameter of the current asset value model, determine a yield value.

The decentralized adaptive state-transition bonding curve smart contract system may be further configured to, based on (i) the intermediate value and (ii) the quantity parameter, determine an updated quantity parameter. The decentralized adaptive state-transition bonding curve smart contract system may be further configured to, based on (i) the interchange value and (ii) the total generated assets parameter, determine an updated total generated assets parameter.

The decentralized adaptive state-transition bonding curve smart contract system may be further configured to, based on (i) the yield value, (ii) the token value, and (iii) the interchange value, transfer a residual token yield value to the computing node. The decentralized adaptive state-transition bonding curve smart contract system may be further configured to, based on (i) the token amount and (ii) the interchange value, update the token amount.

In an example embodiment, the computer network may be a blockchain network. According to an example embodiment, the digital asset may be a non-fungible token (NFT).

Another example embodiment is directed to a computer-implemented method for providing dynamic computational value for digital asset transactions. The method may include receiving an indication of an asset transaction in a digital asset from a computing node. The asset transaction may include an amount of the digital asset. A current asset value model associated with the digital asset may be identified. Based on the amount and the current asset value model, an updated asset value model for the digital asset may be dynamically generated. Using the updated asset value model, an asset value for the digital asset may be determined.

Alternative method embodiments parallel those described above in connection with the example computer-based system embodiments.

It should be understood that example embodiments disclosed herein can be implemented in the form of a method, apparatus, computer-implemented system, or computer readable medium with program codes embodied thereon.

Further details and example embodiments are presented below and in the attached Appendix, entitled “The Forte DEX: An Adjusting Linear Token Bonding Curve,” the contents of which are incorporated herein by reference in their entirety.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a block diagram of an example embodiment of a system for providing dynamic computational value for digital asset transactions.

FIG. 2 is a flow diagram of an example embodiment of a computer-implemented method for providing dynamic computational value for digital asset transactions.

FIG. 3 is a block diagram of an example embodiment of a distributed blockchain ledger computer-implemented system.

FIG. 4 is a block diagram of an example embodiment of a digital processing environment in which an example embodiment may be implemented.

FIG. 5 is a block diagram of an example embodiment of an internal structure of a computer/computing node in the example embodiment of FIG. 4.

FIG. 6 illustrates a constant product invariant for an existing automated market maker (AMM).

FIG. 7 illustrates an existing simple total bonding curve.

FIG. 8 illustrates an example cost function according to an embodiment.

FIGS. 9A and 9B illustrate a comparison of example level curves for different concentration parameter values according to an embodiment.

FIG. 10 illustrates example intermediate and limiting curves according to an embodiment.

FIG. 11 illustrates example excess capital accrual according to an embodiment.

FIGS. 12A and 12B illustrate example sandwich attack mitigation according to an embodiment.

FIG. 13 illustrates an example of maximal extractable value as a function of sandwich attack size.

FIG. 14A illustrates order partitioning in a low supply setting.

FIG. 14B illustrates order partitioning in a higher supply setting than FIG. 14A.

FIG. 15 illustrates example costs to malicious traders of driving up a price as a function of k sizes.

FIGS. 16A-16C illustrate example effects of higher k values on market flexibility.

FIG. 17 illustrates a comparison of an example embodiment and an existing Uniswap® V2 pool on the Dogecoin®-Tether® trading pair.

FIG. 18 illustrates a comparison of an example embodiment and an existing Uniswap V2 pool on the TRON-Circle trading pair.

FIG. 19 illustrates a comparison of an example embodiment and an existing Uniswap V3 pool on the Cardano®-Tether trading pair.

### DETAILED DESCRIPTION

A description of example embodiments follows.

In some embodiments of the disclosure, a decentralized adaptive state-transition bonding curve smart contract system may be implemented within a blockchain-based distributed deterministic state machine. The blockchain network provides consensus-based ordering of transactions, cryptographically secured block formation, and replicated persistent storage across validating nodes. Each node maintains an identical copy of global state and executes smart contract logic deterministically in response to ordered transactions.

In an example embodiment, the decentralized adaptive state-transition bonding curve smart contract system may be configured to operate as a programmable state-transition module deployed as smart contract code. The system maintains a consensus-replicated cumulative quantity state variable stored in contract storage. This variable represents the current position of the mechanism within a bounded state domain and serves as the control index for adaptive system behavior.

An adaptive linear evaluation function of the decentralized adaptive state-transition bonding curve smart contract system may be configured with a slope parameter and an intercept parameter. The slope parameter is deterministically computed as an inverse function of the cumulative quantity state variable and a concentration constant. Because the slope depends solely on the current cumulative quantity value, the mechanism achieves path-independent recalibration and eliminates dependence on historical slope values.

When a blockchain transaction invokes the contract, for example, the distributed execution environment processes the instruction in consensus order. The contract computes a transition delta using a quadratic accumulation function evaluated at pre- and post-modification cumulative quantity values. The cumulative quantity state variable is updated accordingly. The slope parameter is recalculated using the updated cumulative quantity value, and the intercept parameter is adjusted to preserve continuity of the evaluation function. All nodes independently compute identical results, ensuring deterministic system evolution.

In an example embodiment, the decentralized adaptive state-transition bonding curve smart contract system may maintain an adaptive state reserve, which is a consensus-replicated aggregate state register derived from the quadratic accumulation function. The adaptive state reserve stores the accumulated effects of prior state transitions and increases monotonically under cyclic excursions of the cumulative quantity variable. This monotonic property prevents neutral-cost oscillatory manipulation of the state domain and enhances systemic stability.

In an example embodiment, because the slope parameter is preferably recalculated after each state modification, partitioning a modification into multiple smaller transactions results in progressively reduced response sensitivity. As partitioning increases, behavior converges toward a continuous limiting curve defined by rational and logarithmic components dependent solely on cumulative quantity and concentration parameters. This produces predictable scaling characteristics under high-frequency or subdivided inputs.

The decentralized adaptive state-transition bonding curve smart contract system may be configured to exhibit bounded extraction characteristics with respect to transaction reordering. The structure of the adaptive slope function and quadratic accumulation primitive ensures that extractable value from adversarial perturbations is finite and becomes negative beyond a threshold magnitude. This property improves resilience against ordering-based attacks inherent in blockchain systems.

In some implementations, example implementations of a decentralized adaptive state-transition bonding curve smart contract system may operate without reliance on external data feeds or off-chain coordination. Recalibration and state updates may be derived exclusively from consensus-replicated state variables and authenticated transactions executed within the blockchain's virtual machine. As a result, some embodiments of the decentralized adaptive state-transition bonding curve smart contract system may provide a computationally efficient, deterministic, and adversarially robust adaptive state-control architecture for blockchain-based distributed systems.

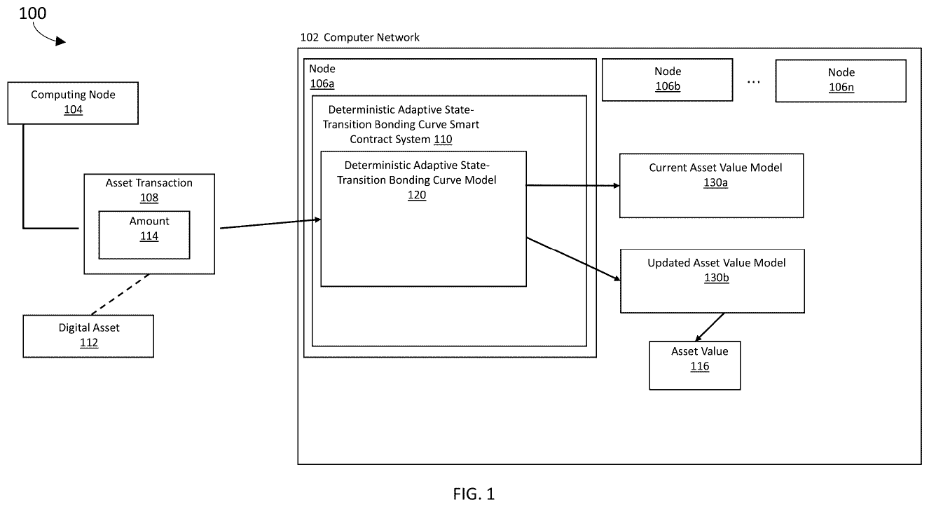

FIG. 1 is a block diagram of an example embodiment of a system 100 for providing dynamic computational value for digital asset transactions. It should be noted that while “value” may be referenced herein, an example implementation of the decentralized adaptive state-transition bonding curve smart contract system 110 is not limited to managing value-related variables; rather, it can govern consensus-replicated state variable whose responsiveness benefits from deterministic, supply-indexed adjustment. For example, the system 110 may regulate resource allocation variables such as compute capacity quotas, storage limits, bandwidth allowances, or API rate limits, with the cumulative quantity state variable indexing overall system utilization. It may also manage access and permission variables, including membership thresholds, credential issuance limits, license availability, or subscription capacity, adaptively adjusting sensitivity as participation grows. In governance contexts, the mechanism can control voting weights, participation scores, or influence coefficients, reducing response sensitivity as cumulative engagement increases. The system 110 may further regulate reputation metrics, issuance rates of digital units or credentials, congestion indices, load-balancing parameters, risk coefficients, or security multipliers. In general, the adaptive architecture can manage any ledger-resident scalar state variable whose transition behavior should evolve predictably as a function of cumulative system activity.

The system 100 comprises a computer network 102 and a computing node 104. The system 100 may implement a distributed deterministic state machine. The network 102 includes multiple nodes, of which nodes 106a-106n are shown, which may be configured to implement a blockchain-based distributed deterministic state machine. It is assumed in FIG. 1 that n, the number of nodes in the network 102, is greater than or equal to three; however, this may not always be the case, as embodiments may function with as little as two nodes 106a and 106b in the multiple nodes of the network 102, or even with a single node 106a rather than multiple nodes.

Continuing with FIG. 1, at least one of the nodes 106a-106n may be configured to execute a decentralized adaptive state-transition bonding curve smart contract system 110. The decentralized adaptive state-transition bonding curve smart contract system 110 may be configured to implement a deterministic adaptive state-transition bonding curve model 120. The deterministic adaptive state-transition bonding curve model 110 may be configured to receive an indication of an asset transaction 108 in a digital asset 112 from the computing node 104. The asset transaction 108 may include an amount 114 of the digital asset 112. The deterministic adaptive state-transition bonding curve model 120 may be further configured to identify a current asset value model 130a associated with the digital asset 112. The deterministic adaptive state-transition bonding curve model 120 may be further configured to, based on the amount 114 and the current asset value model 130a, dynamically generate an updated asset value model 130b for the digital asset 112. The deterministic adaptive state-transition bonding curve model 120 may be further configured to, using the updated asset value model 130b, and determine an asset value 116 for the digital asset 112.

In an example embodiment, the deterministic adaptive state-transition bonding curve model 110 may include a vector field parameter. The deterministic adaptive state-transition bonding curve model 110 may be further configured to dynamically generate the updated asset value model 130b by: (1) based on (i) the amount 114 and (ii) a quantity parameter of the current asset value model 130a, determining an updated quantity parameter of the updated asset value model 130b; (2) based on (i) the updated quantity parameter, (ii) the vector field parameter, and (iii) a coefficient sensitivity parameter of the current asset value model 130a, determining an updated first coefficient parameter of the updated asset value model 130b; (3) based on (i) the updated quantity parameter, (ii) a first coefficient parameter of the current asset value model 130a, (iii) the updated first coefficient parameter, and (iv) a second coefficient parameter of the current asset value model 130a, determining an updated second coefficient parameter of the updated asset value model 130b; and (4) based on (i) the updated quantity parameter, (ii) the updated first coefficient parameter, and (iii) the updated second coefficient parameter, determining the asset value 116 for the digital asset 112.

According to an example embodiment, the decentralized adaptive state-transition bonding curve smart contract system 110 may include a set of digital assets. The asset transaction 108 may be: (i) a transfer of the amount 114 of a first type of digital asset from the set of digital assets to the computing node 104, (ii) a transfer of the amount 114 of the first type of digital asset from the computing node 104 to the set of digital assets, (iii) a transfer of the amount 114 of a second type of digital asset from the set of digital assets to the computing node 104, or (iv) a transfer of the amount 114 of the second type of digital asset from the computing node 104 to the set of digital assets.

In an example embodiment, the deterministic adaptive state-transition bonding curve model 110 may include a vector field parameter. The deterministic adaptive state-transition bonding curve model 110 may be further configured to receive an indication of a computational value increase from the computing node 104. The computational value increase may include a first amount of the digital asset 112 and a second amount of a collateral asset. The deterministic adaptive state-transition bonding curve model 110 may be further configured to, based on (i) the first amount, (ii) the second amount, (iii) a first coefficient parameter of the current asset value model 130a, (iv) a second coefficient parameter of the current asset value model 130a, (v) a quantity parameter of the current asset value model 130a, (vi) a maximum quantity parameter of the current asset value model 130a, (vii) a collateral amount parameter of the current asset value model 130a, (viii) a virtual collateral amount parameter of the current asset value model 130a, (ix) a minimum quantity parameter of the current asset value model 130a, (x) a coefficient sensitivity parameter of the current asset value model 130a, and (xi) a total generated assets parameter of the current asset value model 130a, determine: (i) an updated quantity parameter, (ii) an updated maximum quantity parameter, (iii) an updated minimum quantity parameter, (iv) an updated coefficient sensitivity parameter, (v) an updated virtual collateral amount parameter, (vi) an updated total generated assets parameter, and (vii) a generated asset amount. The deterministic adaptive state-transition bonding curve model 110 may be further configured to, based on (i) the vector field parameter, (ii) the updated quantity parameter, and (iii) the updated coefficient sensitivity parameter, determine an updated first coefficient parameter. The deterministic adaptive state-transition bonding curve model 110 may be further configured to, based on (i) the first coefficient parameter, (ii) the updated first coefficient parameter, (iii) the updated quantity parameter, and (iv) the second coefficient parameter, determine an updated second coefficient parameter. The deterministic adaptive state-transition bonding curve model 110 may be further configured to, based on (i) the updated quantity parameter, (ii) the updated first coefficient parameter, (iii) the updated second coefficient parameter, (iv) the updated minimum quantity parameter, (v) the updated coefficient sensitivity parameter, (vi) the updated virtual collateral amount parameter, and (vi) the updated total generated assets parameter, determine an updated yield value. The deterministic adaptive state-transition bonding curve model 110 may be further configured to, based on (i) the generated asset amount and (ii) the updated yield value, generate a collateral token. The deterministic adaptive state-transition bonding curve model 110 may be further configured to transfer the collateral token to the computing node 104.

According to an example embodiment, the deterministic adaptive state-transition bonding curve model 110 may include a vector field parameter. The deterministic adaptive state-transition bonding curve model 110 may be further configured to receive an indication of (i) an interchange value and (ii) a computational value decrease from the computing node 104. The computational value decrease may include a token. The token may include a token amount and a token value. The deterministic adaptive state-transition bonding curve model 110 may be further configured to, based on (i) the interchange value and (ii) a total generated assets parameter of the current asset value model 130a, determine an intermediate value. The deterministic adaptive state-transition bonding curve model 110 may be further configured to, based on (i) a quantity parameter of the current asset value model 130a, (ii) a first coefficient parameter of the current asset value model 130a, (iii) a second coefficient parameter of the current asset value model 130a, (iv) a minimum quantity parameter of the current asset value model 130a, (v) a coefficient sensitivity parameter of the current asset value model 130a, (vi) a virtual collateral amount parameter of the current asset value model 130a, and (vi) a total generated assets parameter of the current asset value model 130a, determine a yield value. The deterministic adaptive state-transition bonding curve model 110 may be further configured to, based on (i) the intermediate value and (ii) the quantity parameter, and determine an updated quantity parameter. The deterministic adaptive state-transition bonding curve model 110 may be further configured to, based on (i) the interchange value and (ii) the total generated assets parameter, determine an updated total generated assets parameter. The deterministic adaptive state-transition bonding curve model 110 may be further configured to, based on (i) the yield value, (ii) the token value, and (iii) the interchange value, transfer a residual token yield value to the computing node 104. The deterministic adaptive state-transition bonding curve model 110 may be further configured to, based on (i) the token amount and (ii) the interchange value, update the token amount.

In an example embodiment, the computer network 102 may be a blockchain network, blockchain-based distributed deterministic state machine, decentralized distributed ledger-based network, or other digital system where many independent computers (nodes) work together to maintain and update a shared record of data—without relying on a central authority. According to an example embodiment, the digital asset 112 may be any type of ledger-resident state objects. For example, any data object 112 whose creation, ownership, modification, transfer, or destruction is defined by deterministic transition rules and recorded in consensus-replicated storage, such as a blockchain-based distributed deterministic state machine.

A blockchain-based distributed deterministic state machine, for example, can govern a wide range of ledger-resident digital objects whose creation, ownership, modification, transfer, and destruction are defined by deterministic transition rules and recorded in consensus-replicated storage. These digital objects may include fungible digital units, such as programmable tokens, usage credits, governance-weight units, or resource allocation units, which are typically represented as quantity balances associated with public-key identifiers. The system may also govern non-fungible digital objects, including uniquely identifiable certificates, credentials, licenses, access passes, or configuration objects that contain associated metadata and ownership records. In addition, programmable state objects such as time-locked units, conditional release objects, escrowed allocations, or vesting schedules can be enforced entirely through embedded execution logic. The distributed state machine may further manage governance records, voting registers, identity attestations, reputation metrics, compute or storage usage quotas, and other resource-tracking structures. In general, any programmable, ledger-resident digital object whose lifecycle is defined by deterministic execution and validated through consensus may be governed by the blockchain-based system.

Digital assets 112, for example, on blockchain networks may include digitally native items that exist and are recorded on a decentralized ledger, giving them verifiable ownership, transferability, and transparency. Examples include cryptocurrencies like Bitcoin or Ether, which function as native payment tokens of their respective blockchains, and fungible tokens such as stablecoins or governance tokens that provide utility or voting rights within decentralized applications. Other important categories are non-fungible tokens (NFTs), which represent unique items such as digital art, collectibles, memberships, or virtual real estate, and tokenized real-world assets, where traditional assets like real estate, gold, or treasury bills are represented digitally on-chain for easier transfer and fractional ownership. Additionally, utility tokens grant access to services within a platform, security tokens represent regulated financial interests, and identity or soulbound tokens can serve as non-transferable credentials tied to a specific user. Together, these examples showcase how blockchain expands the definition of “digital assets” far beyond currency, enabling new models of ownership, access, and rights management.

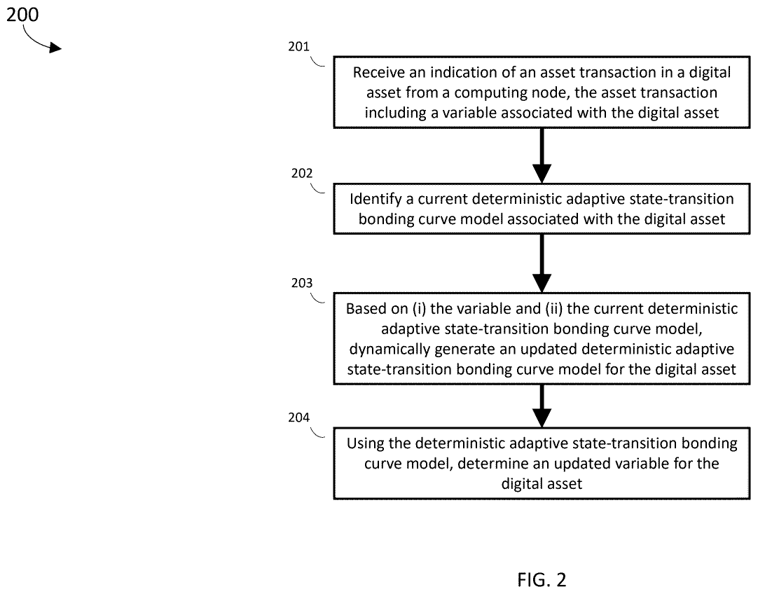

FIG. 2 is a flow diagram of an example embodiment of a computer-implemented method 200 for providing dynamic computational value for digital asset transactions such as the asset transaction 108 of the system 100 of FIG. 1. The method 200 begins at step 201 by receiving an indication of an asset transaction, e.g., 108, in a digital asset, e.g., 112 (FIG. 1), from a computing node, e.g., 104 (FIG. 1). The asset may include a consensus-replicated state variable associated with the asset whose responsiveness benefits from deterministic, supply-indexed adjustment., such as a value, capacity quota, storage limit, bandwidth allowance, API rate limit; access and permission variable, including membership thresholds, credential issuance limits, license availability, or subscription capacity, which can be, for example, adaptively adjusted by the deterministic adaptive state-transition bonding curve model to calibrate sensitivity as participation grows in steps 202-204 (FIG. 1).

At step 202, the method 200 identifies a current deterministic adaptive state-transition bonding curve model, e.g., 130a (FIG. 1), associated with the digital asset. At step 203, based on the variable and the current deterministic adaptive state-transition bonding curve model, the method 200 then dynamically generates an updated deterministic adaptive state-transition bonding curve model, e.g., 130b (FIG. 1), for the digital asset. In turn, at step 204, using the updated asset value model, the method 200 determines an asset value, e.g., 116 (FIG. 1), for the digital asset.

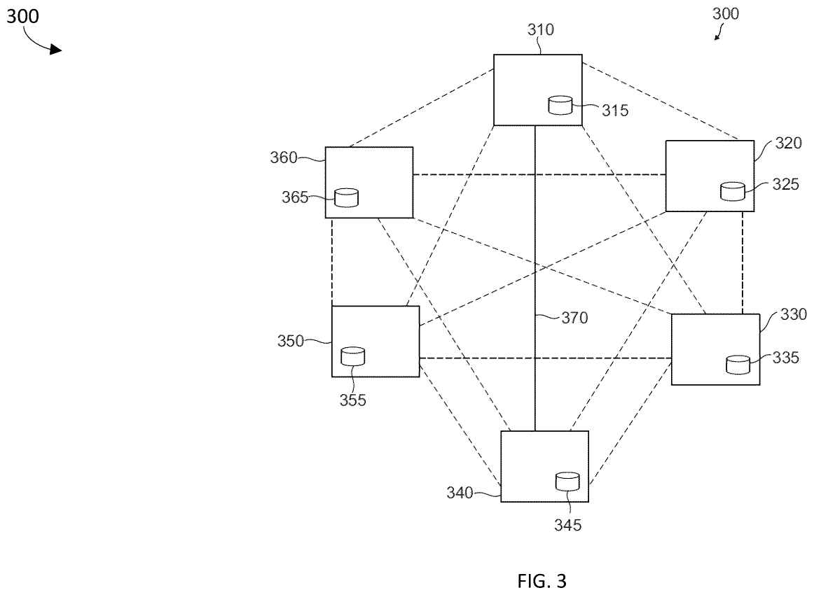

FIG. 3 is a block diagram of an example embodiment of a blockchain network 300, also referred to interchangeably herein as a distributed ledger network 300, that may be accessed according to an example embodiment. The blockchain network 300 may be employed as the computer network 102 of FIG. 1, disclosed above. The blockchain network 300 is a distributed ledger peer-to-peer network and is valuable because this network enables trustworthy processing and recording of transactions without the need to fully trust any user (e.g., person, entity, program, and the like) involved in the transactions, reducing the need for trusted intermediaries to facilitate the transaction. Existing applications use the distributed ledger network 300 to transfer and record, in the form of blockchain based records, movement of tokens. Such blockchain based records form a cryptographically secured backlinked list of blocks.

The distributed ledger network 300 comprises multiple computing devices configured as nodes 310, 320, 330, 340, 350, 360 of the distributed ledger network 300. Each node 310, 320, 330, 340, 350, 360 locally stores and maintains a respective identical copy 315, 325, 335, 345, 355, 365 of the blockchain ledger in memory communicatively coupled to the node. The nodes exchange messages within the distributed ledger network 300 to update and synchronize the ledger stored and maintained by each node. The nodes may also execute decentralized applications (e.g., via smart contracts) for processing the messages. A message transmission 370 from node 310 to node 340 may be used to exchange a token in the distributed ledger network 300 as shown in FIG. 3. The dotted lines between each set of nodes in the distributed ledger network 300 indicate similar transmissions that may be exchanged between any other set of nodes in the distributed ledger network 300. The messages may include a confirmed transfer for recording data associated with the token being transferred, a blockchain public key for each of the one or more parties participating in the transfer.

Referring back to FIG. 1, according to an example embodiment, the computer network 102 may be an Ethereum network; however, it should be understood that the computer network 102 may be any suitable blockchain network. Ethereum is a decentralized network of computers with two basic functions, a blockchain that can record transactions and a virtual machine, that is, an Ethereum Virtual Machine (EVM), that can produce smart contracts. Because of these two functions, Ethereum is able to support decentralized applications (DApps). These DApps are built on the existing Ethereum blockchain, piggybacking off of its underlying technology. In return, Ethereum charges developers for the computing power in their network, which can only be paid in Ether, the only inter-platform currency. Depending on its purpose, a DApp may create ERC20 tokens to function as a currency. According to an example embodiment, fungible tokens disclosed herein may be ERC20 tokens or any other suitable fungible token.

The code of the smart contract may be uploaded on the EVM, that may be a universal runtime compiler or browser, to execute the smart contract's code. Once the code is on the EVM, the code may be the same across each Ethereum node to be run to check whether the conditions are met, such as a condition for the balance reaching the trade value prior to expiration of the expiration term.

Ethereum has a long history of developed standards. For example, the Ethereum Request for Comment (ERC) issue number 20, that is, ERC20, is a standard that defines a set of six functions that other smart contracts within the Ethereum computer-implemented system can understand and recognize. ERC20 is a protocol standard and in order to be ERC20 compliant, the functions need to be included in the token's smart contract. ERC20 outlines a specific list of rules that a given Ethereum based token has to deploy, simplifying the process of programming the functions of tokens on Ethereum's blockchain. These include, for instance, how to transfer a token (by the owner or on behalf of the owner), such as may be employed for transferring fungible tokens of the buyer, and how to access data (name, symbol, supply, balance) about the token, such as an asset value 116 of the digital asset 112 of the system 100.

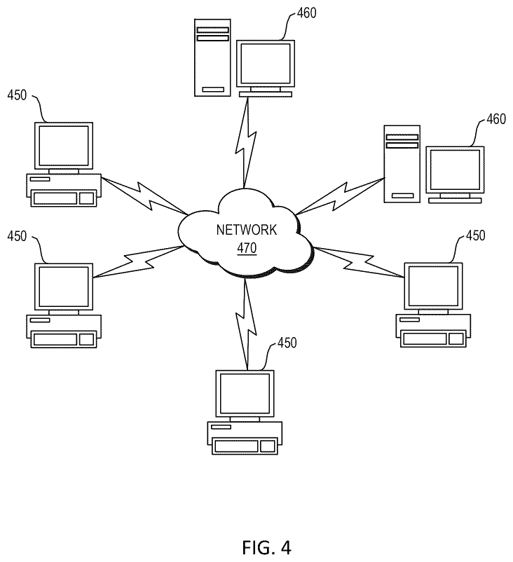

FIG. 4 is a block diagram of an example digital processing environment in which an example embodiment may be implemented. Client computers/devices 450 and server computers/devices 460 provide processing, storage, and input/output devices executing application programs and the like.

Client computers/devices 450 are linked through communications network 470 to other computing devices, including other client computers/devices 450 and server computer(s) 460. The network 470 can be part of a remote access network, a global network (e.g., the Internet), a worldwide collection of computers, Local area or Wide area networks, and gateways that may use respective protocols (e.g., TCP/IP, Bluetooth®, etc.) to communicate with one another. Other electronic device/computer network architectures are suitable. For example, client computers/devices 450 may include nodes shown in FIG. 3, which run user applications that enable a user to communicate with an application to determine whether a user meets a work requirement. A blockchain network, such as the computer network 102, may be configured on each user device 310, 320 to store tokens. Client computers 350 of the system 100 may be configured with a trusted execution environment (TEE) or trusted platform module (TPM), where the application may be run and digital assets, collateral assets, and collateral tokens may be stored.

Server computers 460 of the computer-implemented system may be configured to include a server that that executes the application. For example, the application of the server computer 460 may determine whether a user has satisfied a work requirement and produce a determination result and pair, in computer memory, an indication of the determination result with an identifier of the user or an identifier of a digital asset of the user, such as an address of a node of a blockchain network accessible by the user. The application of the server computer 460 also facilitates a transfer of a collateral token by moving the collateral token to, for example, a digital wallet implemented upon a blockchain network. For another example, server computers 460 or client devices 450 may comprise peer computing devices (nodes) 310, 320, 330, 340, 350, 360 of a distributed blockchain ledger 300 of FIG. 3, which use smart contracts to execute and record transactions implemented via tokens.

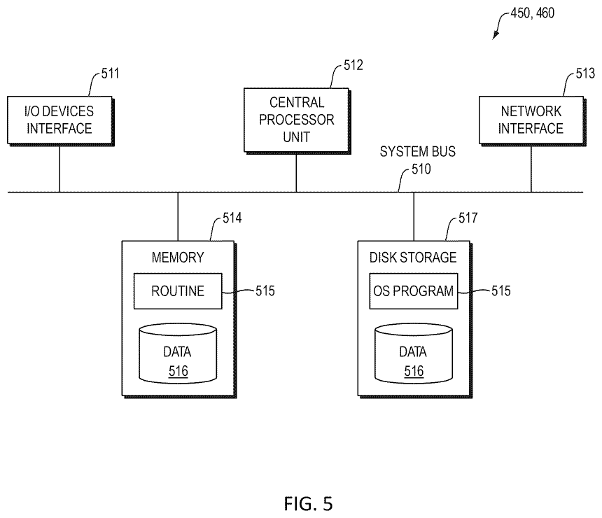

FIG. 5 is a block diagram of an example embodiment of an internal structure of a computer/computing node (e.g., client processor/device/mobile phone device/tablet/video camera, or computer 450, 460) in the digital processing environment of FIG. 4, which may be used to facilitate displaying audio, image, video or data signal information. An example embodiment may include means for displaying audio, image, video or data signal information. The computer 450, 460 in FIG. 5 may include a computer-implemented system bus 510, where a bus is a set of actual or virtual hardware lines used for data transfer among the components of a computer or processing computer-implemented system. Bus 510 is essentially a shared conduit that connects different elements of a computer computer-implemented system (e.g., processor, disk storage, memory, input/output ports, etc.) that enables the transfer of data between the elements.

Coupled to the computer-implemented system bus 510 is an I/O device interface 511 for connecting various input and output devices (e.g., keyboard, mouse, touch screen interface, displays, printers, speakers, audio inputs and outputs, video inputs and outputs, microphone jacks, etc.) to the computer 450, 460. The network interface 513 allows the computer to connect to various other devices attached to a network, such as the network 470 of FIG. 4, disclosed above. The memory 514 provides volatile storage for computer software instructions 515 and data 516 used to implement applications and software implementations of components.

Software components 514, 515 of the computer-implemented system may be configured using any known programming language, including any high-level, object-oriented programming language. The computer-implemented system may include instances of processes that enable execution of transactions and recordation of transactions. It should be understood that the terms “transaction” and “exchange” are herein used interchangeably, when used within a context of digitally transferring items of value, such as digital assets, collateral assets, and collateral tokens, among entities associated with a blockchain network. The computer-implemented system may communicate with the server 460 using, for example, secure sockets layer (SSL), or any other suitable protocol.

In an example mobile implementation, a mobile agent implementation may be provided. A client-server environment can be used to enable mobile services using a network server. It can use, for example, the Extensible Messaging and Presence Protocol (XMPP) to tether an agent 515 on the device 450 to the server 460. The server 460 can then issue commands to the mobile device on request. The mobile user interface framework used to access certain components of the computer-implemented system 501 may be based on XHP, Javelin, or WURFL. In another example mobile implementation for OS X and iOS operating computer-implemented systems and their respective APIs, Cocoa and Cocoa Touch may be used to implement the client-side components 515 using Objective-C or any other high-level programming language that adds Smalltalk-style messaging to the C programming language.

The disk storage 517 provides non-volatile storage for computer software instructions 515 (equivalently “OS program”) and data 516 used to implement embodiments of the computer-implemented system. The central processor unit 512 is also coupled to the computer-implemented system bus 510 and provides for the execution of computer instructions.

According to an example embodiment, the processor routines 515 and data 516 are computer program products, e.g., application and smart contracts (generally referenced 515), including a computer readable medium capable of being stored on a storage device 517, which provides at least a portion of the software instructions for the computer-implemented system. Executing instances of respective software components of the computer-implemented system, such as instances of the application and smart contracts may be implemented as computer program products 515, and can be installed by any suitable software installation procedure, as is well known in the art. In another example embodiment, at least a portion of the computer-implemented system software instructions 515 may also be downloaded over a cable, communication and/or wireless connection via, for example, a browser SSL session or through an app (whether executed from a mobile or other computing device). According to another example embodiment, the computer-implemented system software components 515 may be implemented as a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals may provide at least a portion of the software instructions for the computer-implemented system.

An example embodiment includes device code executed in the TEE or TPM. The TEE or TPM is a hardware environment that runs instructions and stores data outside the main operating computer-implemented system (OS) of a device. This protects sensitive code and data from malware or snooping with purpose-built hardware governed by a computer-implemented system of endorsements, beginning with the device manufacturer. The computer-implemented system may perform checks on the TEE or TPM, such as executing BIOS checks, to verify that the folders (e.g., wallets) stored in the TEE/TPM have not been altered by malicious actors.

The decentralized adaptive state-transition bonding curve smart contract system may be implemented by any protocol (e.g., ERC20 etc.).

Further example embodiments disclosed herein may be configured using a computer program product; for example, controls may be programmed in software for implementing example embodiments. Further example embodiments may include a non-transitory computer-readable medium containing instructions that may be executed by a processor which, when loaded and executed, cause the processor to complete methods described herein. It should be understood that elements of the block and flow diagrams may be implemented in software or hardware, such as via one or more arrangements of circuitry of FIG. 5, disclosed above, or equivalents thereof, firmware, a combination thereof, or other similar implementation determined in the future. In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as random access memory (RAM), read only memory (ROM), compact disk read-only memory (CD-ROM), and so forth. In operation, a general purpose or application-specific processor or processing core loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments disclosed herein.

While example embodiments have been particularly shown and described, it will be understood by those skilled in the art that various changes in form and details may be made therein without departing from the scope of the embodiments encompassed by the appended claims.

### Overview of Example Embodiments

Some embodiments are directed to a decentralized finance (DeFi) adaptive state control system, which may be referred to herein as an “Adjusting Linear Token Bonding Curve” (ALTBC). An example embodiment may provide a pricing mechanism that automatically updates its price curve in response to arriving trades. Unlike existing systems, an example embodiment may no active management, while automatically bounding maximal extractable value (MEV). Additionally, an example embodiment may be designed to increase local variable stability as a function of demand, which makes it ideal for projects that wish to promote stable, long-term economies rather than economies fueled by short-term speculation.

Provided hereinbelow is a demonstration of how example embodiments differ from existing market makers. Also provided hereinbelow are comparisons of the behavior of example embodiments with existing market makers, using real-world historical trade data. Further computational and numerical details are provided hereinbelow.

### Existing Approaches and Preliminary Discussion

The DeFi liquidity landscape has evolved dramatically over the last decade. Today, there exists a broad range of liquidity protocols, each with different strengths and intended uses. Provided hereinbelow is a discussion of some relevant existing techniques.

### AMMs and TBCs

Provided hereinbelow is a review of some terminology and common existing DeFi market making techniques. Also provided hereinbelow is a discussion of how example embodiments differ from the existing techniques. Further provided hereinbelow is a discussion of the difference between an existing AMM and an existing TBC, and a demonstration of how example embodiments differ from both.

The most common existing way to provide decentralized liquidity on chain is through AMMs. Less commonly discussed, but related, mechanisms are TBCs.

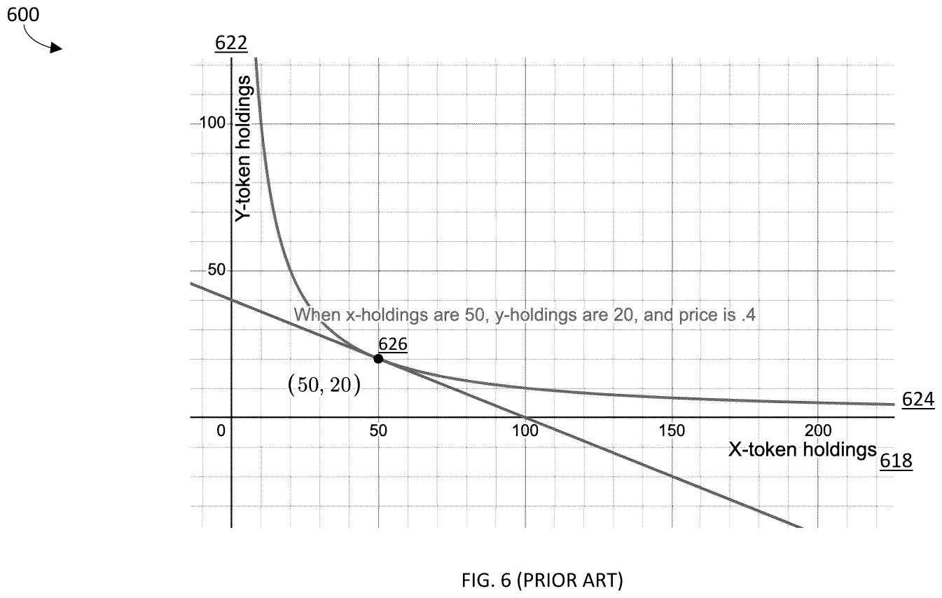

FIG. 6 is a graph 600 illustrating a constant product invariant 624 for an existing AMM. In FIG. 6, axes 618 and 622 represent amounts of tokens X and Y, respectively, held in a pool. Spot price is given by the negative slope of a given tangent line along the curve 624. For instance, at point 626 with X-holdings 618 of 50 and Y-holdings 622 of 20, a tangent line 628 results in a spot price of 0.4.

The constant product invariant shown in FIG. 6 underpins many of the most popular existing AMMs in DeFi. Geometric Mean Market Makers are a generalization of existing constant product market makers (CPMMs).

Existing AMMs and TBCs are usually treated separately, with the latter being used to sell tokens that are not yet circulating widely (during a so-called “bootstrapping” phase), or for issuing NFTs one at a time. However, these two mechanisms are in some cases mathematically equivalent. Specifically, for a finite trading range (for example, a single Uniswap V3 tick range), an existing AMM pricing rule can be transformed into a single, finite TBC. Existing static AMMs and TBCs may thus be thought of as different views of the same basic mathematical structure. However, the two are used in different settings and result in different user impressions.

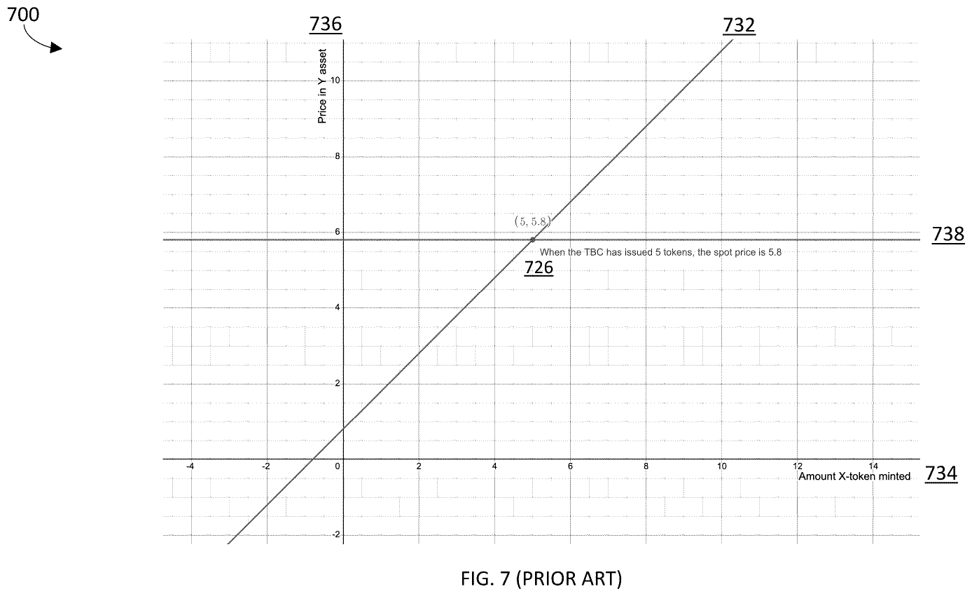

FIG. 7 is a rendering 700 of a simple existing TBC 732. In FIG. 7, the TBC 732 maps an amount of X token minted on x-axis 734 to a price in Y asset on y-axis 736. For instance, at point 726 with 5 X tokens issued 734, the spot price 736 is 5.8 Y tokens, as shown by line 738.

### Updating Price Rules

In view of the discussion hereinabove, it may be said that the two most common existing liquidity providing techniques—AMMs and TBCs—are mathematically equivalent. Provided hereinbelow is a discussion of how existing AMMs and TBCs—both of which rely on invariant bonding curves—differ from example updating price functions or rules of example embodiments, which may have logic that is adjustable, adaptive, and/or can change over time.

An example embodiment may include a line with one or more parameters that adapt (e.g., constantly adapt) in response to the arrivals of trades. With a buy trade, for example, the slope of the line (corresponding to the sensitivity of the price to trade size) may go down. In this way, price becomes less volatile with increased demand. While example price functions are depicted in the accompanying drawings in so-called “TBC-space” where the x-axis is the amount minted and the y-axis is price, it should be noted that any such drawing merely shows a snapshot in time (which TBC snapshot may be referred to herein as an “intermediate TBC”), whereas the underlying price functions are in fact changing or adapting.

Several existing projects have used price oracles to update their pricing curves, often with the goal of mitigating losses to arbitrageurs. The existing Arrakis HOT AMM, Lifinity protocol, Swaap Finance Matrix-MM, and DODO “proactive market maker” all rely on price oracles to keep quotes from going stale and reduce a pool's vulnerability to informed traders.

These existing projects, and others like them, are updating price rules. In other words, their price rules can vary over time (unlike in Uniswap V2 or a standard existing TBC). However, it is important to distinguish between these existing approaches, which rely on oracles and where updates can happen independently of trades, and an example updating price rule according to an embodiment. Unlike these existing oracle-based approaches, an example ALTBC according to an embodiment may update (e.g., exclusively update) in response to trader activity, not external price feeds. Moreover, an example embodiment may update to optimize for economic health and capital accumulation, rather than arbitrage mitigation. This makes an example mechanism according to an embodiment fully decentralized and community oriented. Curve Finance has released two existing projects—StableSwap (for trading stablecoins) and CryptoSwap (a more complex mechanism for all-purpose cryptocurrency trading)—that are not oracle-based, with curve updates that occur in response to arriving trades. These existing projects achieve a high degree of control over price impact. However, unlike example embodiments, they address different issues and have different use cases.

### Example Use Cases

An example embodiment can be used to bootstrap liquidity without providing initial collateral as is required with a conventional AMM. For this reason, it is ideal for new projects where tokens have not had time to circulate widely.

Moreover, an example embodiment may have a unique way of accruing capital without relying on separate buy and sell functions, and even before standard fees are imposed. Such capital accrual properties of an example embodiment may be referred to herein as “smart fees.” This makes an example embodiment a good fit for community-oriented tokens where the market maker wishes to incentivize behaviors that enrich the community as a whole.

An example embodiment may also produce less and less volatility as more X-token circulates. This makes it a good home for projects that wish to promote thriving, stable economies rather than economies fueled by short-term speculation.

### Example Operation in a Closed System

It should be noted that, in the discussion hereinbelow, and solely for purposes of illustration, an example ALTBC according to an embodiment may be considered as the only market for X-token. Thus, considerations or metrics that depend upon external markets may not be relevant. For instance, the loss-versus-holding metric depends on having another place to liquidate portfolio holdings. If the market owner is considered as the sole liquidity provider (LP), this metric cannot apply.

### Example Design Approach

An example ALTBC according to an embodiment may include a line with a slope and intercept that adapt to the arrival of trades. Thus, an example price function according to an embodiment may have the form below:

$${f}_{n} ( x ) = {b}_{n} x + {c}_{n}$$

In an implementation, an example price function may be subscripted fₙ because, for any given moment in the curve's lifetime, a different line will apply, depending on the history of updates. Example logic governing updates is detailed hereinbelow, but it should be noted that adjustments according to an embodiment may ensure the following non-limiting example properties:
a) price increases as more tokens enter circulation;
b) price impact decreases as more tokens enter circulation (inverse volatility); and
c) collateral continually accrues with each trade, even when supply returns to previous levels.

According to an aspect, collateral may be defined as the value in Y-token of all the X-token that traders have purchased from the market. Examples of price and collateral monotonicity are provided hereinbelow.

### Example Constant Variables

Table 1 below lists non-limiting example constant variables according to an embodiment. According to an aspect, a constant variable may be set once upon instantiation and never altered again.

TABLE 1
Example constant variables according to an embodiment.

| | | Definition |
|---|---|---|
| Description | Variable | or Bounds |
| Initial tokens deposited into TBC | x_{add} | x_{add} > 0 |
| y-intercept upon TBC initialization | p_{lower} | p_{lower} ≥ 0 |
| Vector Field Parameter | V | V > 0 |
| Initial Concentration Parameter | C₀ | C₀ > 0 |
| Initial minimum value of x | xₘᵢₙ⁽⁰⁾ | xₘᵢₙ⁽⁰⁾ > 0 |
| Liquidity units assigned to deployer | W₀ | W₀ > 0 |
| at pool initialization | | |
| Deployer's inactive liquidity units | W₀¹ | W₀ > W₀¹ > 0 |
| at launch | | |
| Initial trading fee | φ₀ | φ₀ ≥ 0 |
| Initial protocol fee | ψ₀ | ψ₀ ≥ 0 |

### Example Updated Variables

Table 2 below lists non-limiting example updated variables according to an embodiment. In an implementation, an updated variable may be a quantity that is maintained over time and/or updated with each transaction.

TABLE 2
Example updated variables according to an embodiment.

| Description | Variable | Initial value |
|---|---|---|
| Vector Field Param. | V | V (constant) |
| Value of x before n-th txn | xₙ | x₀ = xₘᵢₙ⁽⁰⁾ |
| Area under TBC curve before | Dₙ | D₀ = D(xₘᵢₙ⁽⁰⁾, b(0, C₀, |
| n-th txn | | V₀), p_{lower}) |
| Parameter b before n-th txn | bₙ | b₀ = b(xₘᵢₙ⁽⁰⁾, C₀, V₀) |
| Parameter c before n-th txn | cₙ | c₀ = c(xₘᵢₙ⁽⁰⁾, b(xₘᵢₙ⁽⁰⁾, |
| | | C₀, V₀), b(0, C₀, V₀), p_{lower}) |
| Spot price before n-th txn | pₙ | p₀ = p(xₘᵢₙ⁽⁰⁾, b₀, c₀) |
| Concentration param. | Cₙ | C₀ |
| Minimum value of x | xₘᵢₙ⁽ⁿ⁾ | xₘᵢₙ⁽⁰⁾ |
| Maximum value of x | xₘₐₓ⁽ⁿ⁾ | xₘₐₓ⁽⁰⁾ = xₘᵢₙ⁽⁰⁾ + x_{add} |
| Sum of NFT amounts | Wₙ | W₀ |
| Deployer's inactive liquidity | Wₙ^{I} | W₀¹ |
| LP fee balance adj. | Zₙ | Z₀ = 0 |
| Trading fee ratio | φ | φ₀ (constant) |
| Protocol fee ratio | ψ | ψ₀ (constant) |
| Claimable trading fees per | Φₙ | 0 |
| unit active liquidity | | |
| Total protocol fees per unit | Ψₙ | 0 |
| active liquidity | | |

Discussed hereinbelow are examples of some updated variables according to embodiments.

### Example Supply Values

According to an aspect, the x_{add} value may represent the maximum number of X tokens an example ALTBC can sell. The value may also represent, equivalently, the amount of X tokens deposited into a pool upon instantiation. In an implementation, the xₘᵢₙ value may represent the lowest possible x-value the price curve can achieve. According to an embodiment, the sum of these two numbers may represent the upper bound on x for an example ALTBC. In an aspect, transactions that would push the x-value outside a realizable trading region denoted as (xₘᵢₙ, xₘᵢₙ+x_{add}) may be rejected, preempted, or fail.

### Example Concentration Parameter

In an embodiment, the concentration parameter C may be a number that informs the slope update's sensitivity to order size. According to an aspect, the concentration parameter may be set at initialization and change (e.g., change exclusively) with liquidity changes. Examples of adding and withdrawing liquidity are discussed in further detail hereinbelow. In an implementation, an initial value of the concentration parameter may be determined by the example parameter setting process discussed hereinbelow.

### Example Vector Field Parameter

According to an embodiment, the vector field parameter V may control the sensitivity of the slope field to trade size. A higher V value may, in general, produce more price volatility. This can be seen by examining the below example slope field equation, which maps an x-value to the slope of the pricing line:

$$s ( x ) = \frac{V}{x + C}$$

In the example equation above, when x and C are held constant, the slope s may increase for increasing values of the vector field parameter V. Thus, V may serve as a tuning parameter for an example ALTBC where higher values of V may lead to more price fluctuation. In an implementation, like the concentration parameter C, an initial value for the vector field parameter V may be an output of an example parameter setting process.

### Example ALTBC Functions

Table 3 below lists non-limiting example ALTBC functions that may be employed by embodiments.

TABLE 3
Example ALTBC functions according to an embodiment.

| Function | Equation | Meaning |
|---|---|---|
| D(xₙ₊₁, bₙ, cₙ) | $\frac{1}{2} \text{?} \text{?} + \text{?} \text{?}$ | Area under curve. |
| b(xₙ, Cₙ, V) | $\frac{V}{\text{?}}$ | Slope of pricing function. |
| c(xₙ₊₁, bₙ₊₁, bₙ, cₙ) | $\frac{1}{2} ( \text{?} - \text{?} ) \text{?} + \text{?}$ | Floor price. |
| p(xₙ, bₙ, cₙ) | bₙxₙ + cₙ | Spot price. |
| $L ( \text{?} , \text{?} , \text{?} , \text{?} , \text{?} , V )$ | $\frac{1}{2} \text{?} ( \text{?} \text{?} + 2 \text{?} + V \text{?} ( \frac{\text{?}}{\text{?}} ) )$ | Limiting TBC Primitive. |
| $h ( \text{?} , \text{?} , \text{?} , \text{?} , \text{?} , V , \text{?} , \text{?} , \text{?} , \text{?} )$ | $\frac{L ( \text{?} ) + \text{?}}{\text{?}} + \text{?}$ | Revenue Parameter. |

### Example Cost Functions

To actually execute a transaction, in addition to the spot price, an embodiment may utilize one or more example functions (e.g., cost functions) that take in a transaction amount, and output the cost for that order size and trade direction. To evaluate the cost of a buy or sell order of X-token, an embodiment may perform one or more of the following non-limiting example steps:
a) Calculate the value in Y token of current outstanding supply.
b) Calculate the value in Y token of current outstanding supply plus transaction amount.
c) Take the difference between (a) and (b) to give the cost in Y token of transacting the proposed amount.

To evaluate the cost of a buy or sell order of Y-token, an embodiment may perform one or more of the following non-limiting example steps:
a) Calculate the value in X token of current collateral.
b) Calculate the value in X token of current collateral plus transaction amount.
c) Take the difference between (a) and (b) to give the cost in X token of transacting the proposed amount

Table 4 below lists non-limiting example cost functions according to an embodiment.

TABLE 4
Example cost functions according to an embodiment.

| Variable | Description | Input | Output |
|---|---|---|---|
| Fₙ | Cost Function | x-token transaction amount | value in |
| | | | y-token |
| Fₙ⁻¹ | Inverse Cost | y-token transaction amount | value in |
| | Function | | x-token |

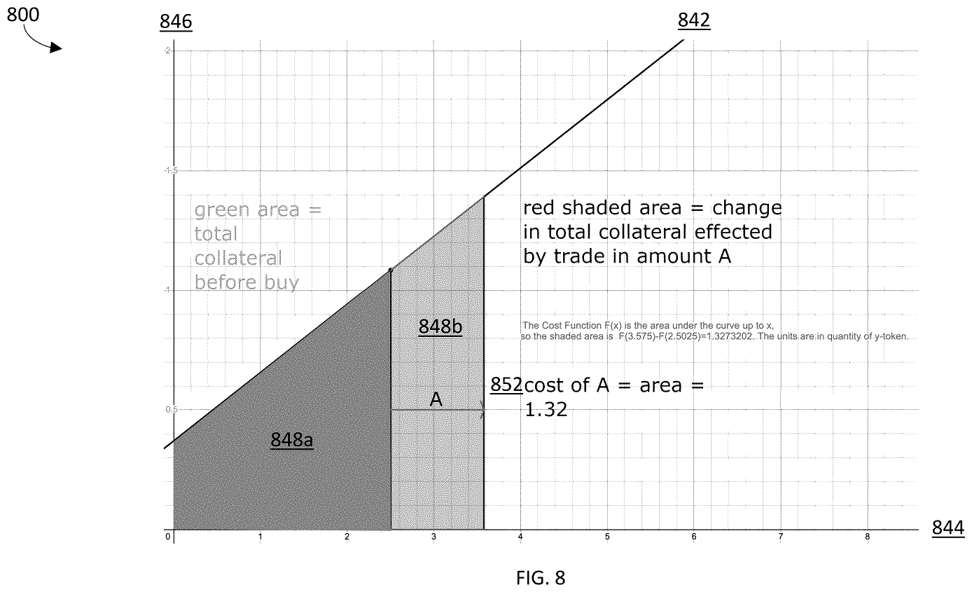

FIG. 8 is a graph 800 illustrating an example cost function Fₙ(x) 842 according to an embodiment. In an embodiment, the cost function 842 takes as input an X token transaction amount 844, and outputs a transaction cost 846 in Y token. As shown in FIG. 8, when current total collateral (i.e., prior to the next transaction) is as shown by area 848a for amount 2.5025 of X token, a buy transaction for X token in amount A of 1.0725 may cause a change in total collateral from 2.5025 to 3.575 as shown by area 848b. The function 842 may determine a cost 852 of 1.32 Y token for the transaction based on the area 848b.

### Example Level Curves

In an implementation, an example ALTBC may have a line that adapts. For instance, a given x value may be mapped to a unique slope value. This may be achieved with a slope field, which may be defined as the following example family of level (i.e., log [ln]) curves:

$$g ( x ) = ln ( x + C ) + K$$

According to an aspect, the variable K in the above example equation may shift the level curves up or down. The variable K is shown above for purposes of illustrating the example family of level curves, but it may not be considered a variable of an example ALTBC according to an embodiment.

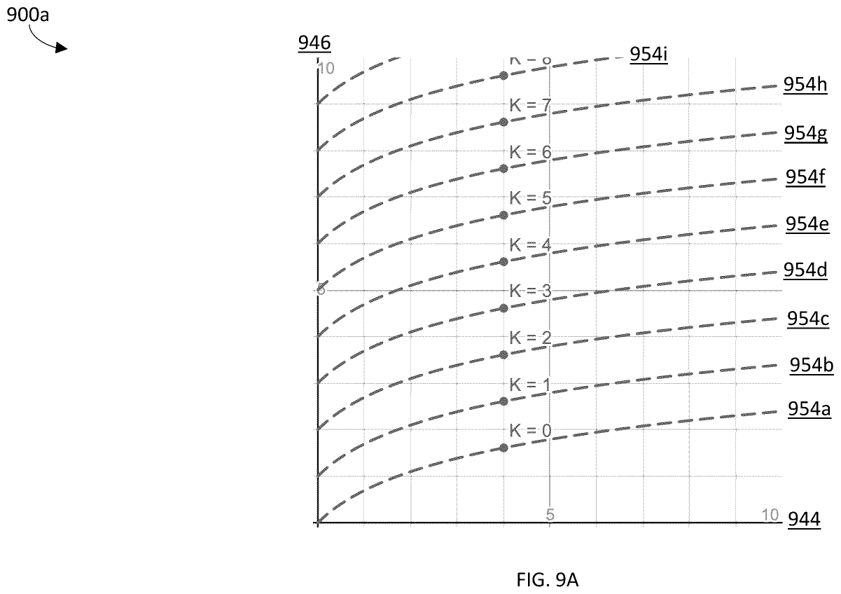

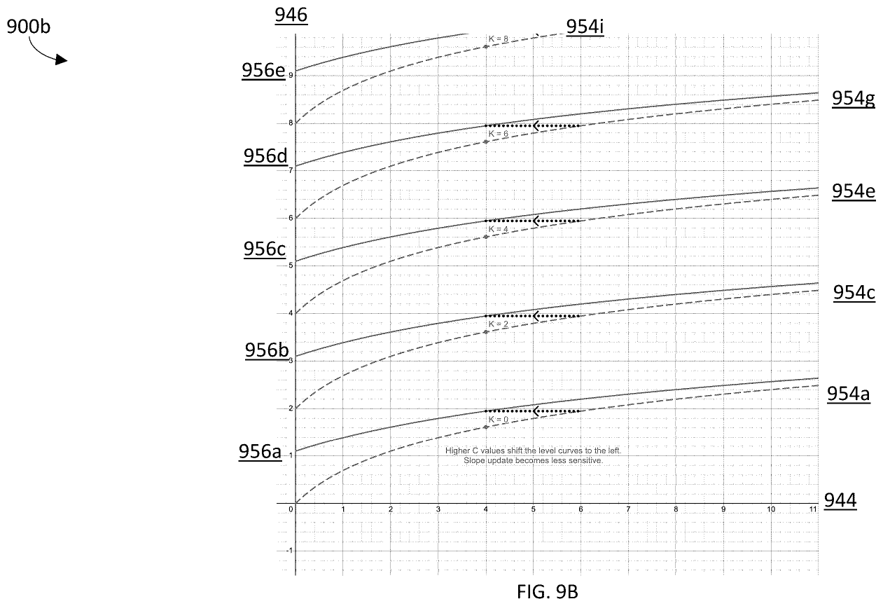

FIGS. 9A and 9B illustrate a comparison of level curves for different values of concentration parameter C according to an embodiment.

FIG. 9A is a graph 900a illustrating level curves 954a-954i when a value of the concentration parameter is 1. The graph 900a has axes of x values 944 and y values 946. As shown in FIG. 9A, the curves 954a-954i correspond to values for variable K of 0-8, respectively.

FIG. 9B is a graph 900b illustrating the level curves 954a, 954c, 954e, 954g, and 954i when a value of the concentration parameter is 3. The graph 900b has axes of x values 944 and y values 946. As shown in FIG. 9B, increasing the concentration parameter from 1 to a higher value of 3 shifts the curves 954a, 954c, 954e, 954g, and 954i to the left, resulting in modified curves 956a, 956b, 956c, 956d, and 956e, respectively.

According to an embodiment, the variable C may be referred to as the “concentration parameter” because it may control the degree of concentration of price in a given supply range. The concentration parameter may achieve this by shifting level curves left and right, effectively controlling the slope update's sensitivity to changes in outstanding supply. Geometrically, higher concentration parameter values may shift level curves to the left as described hereinabove with respect to FIG. 9B. According to an aspect, level curves may thus be closer to flat at lower values of supply, which may produce greater price stability or, equivalently, less sensitivity in slope updates.

Table 5 below describes an example concentration parameter C according to an embodiment.

TABLE 5
Example concentration parameter according to an embodiment.

| Description | Variable | Bounds |
|---|---|---|
| Concentration Parameter | C | C > 0 |

In an implementation, slope may be a deterministic function of supply, thereby generalizing a TBC. According to an aspect, a line fₙ(x) may be tangent to a level curve that passes through the point (xₙ, pₙ) (i.e., the point of tangency) where xₙ is the current x-value and pₙ is the current spot price. It should be noted that, in an embodiment, while a given x-value may not determine a unique price (e.g., because there may be many lines with a given slope), it may determine a unique slope bₙ. According to an aspect, the property of a unique slope bₙ existing for a given supply value xₙ may be referred to as the “path independence of slope.” This notable property of some example embodiments is discussed in further detail hereinbelow.

It should be noted that, in an embodiment, the path independence of slope property may result in slope bₙ, not price pₙ, being a deterministic function of supply xₙ. Put differently, according to an aspect, price impact rather than price may be a function of supply.

### Example Limiting and Intermediate TBCs

In an embodiment, an intermediate TBC may refer to an individual fₙ(x) pricing function. According to an aspect, a limiting TBC may be a curve representing optimal obtainable prices for a trader. In an implementation, optimal prices may be obtainable if a trader is granted the ability to split orders into infinitely many smaller suborders. Put another way, in general, a limiting TBC may not resemble the actual price curve yielded by an example ALTBC according to an embodiment. It should also be noted that when the minimum trade size is a single “micro unit” of a given token, e.g., 1/10¹⁸ ETH (Ethereum), a limiting TBC may not be achievable, e.g., in the discrete setting of the EVM (Ethereum Virtual Machine). The concept of a limiting TBC is nevertheless useful in understanding the operation of an ALTBC according to an embodiment. Further details of the limiting TBC concept are provided hereinbelow.

According to an embodiment, a limiting TBC at any point may be defined by the following example equation:

$${f}_{lim} ( x ) = {p}_{n} + \frac{1}{2} ( \frac{x}{x + C} - \frac{{x}_{n}}{{x}_{n} + C} ) + \frac{1}{2} ln ( \frac{x + C}{{x}_{n} + C} )$$

where xₙ is the x value at time n, pₙ is the current price, and C is the concentration parameter.

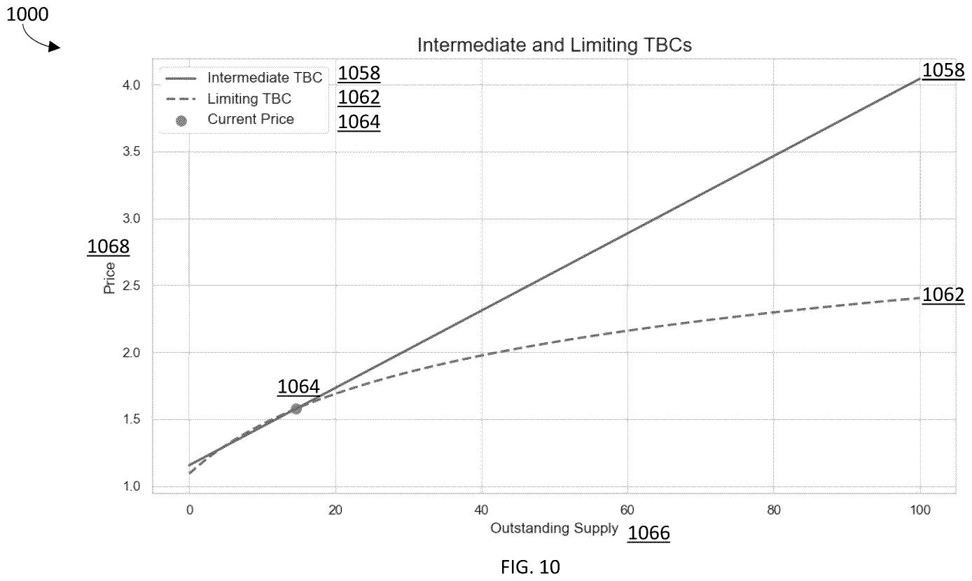

FIG. 10 is a graph 1000 illustrating example intermediate 1058 and limiting 1062 TBCs according to an embodiment. The graph 1000 depicts prices 1068 as a function of outstanding supply 1066. As shown in FIG. 10, the limiting TBC 1062 represents the prices 1068 a trader would obtain if infinite order splitting were possible. The intermediate TBC 1058 is a tangent line along the curve 1062 at a point corresponding to current price 1064.

### Example Liquidity Positions

In an implementation, ownership of a pool (e.g., by developers and/or liquidity providers) may be represented by one or more NFTs. The NFT(s) may store the following information, for non-limiting example:

$$NFT ( \{ amount : a , last\_revenue \_claim : r \} ) . \qquad ( 1 )$$

In the example data structure (1) above, the amount a may store the total number of units of liquidity owned by the NFT. The last_revenue_claim quantity r may store a number that benchmarks the total amount of liquidity at the time of a given liquidity add, thus ensuring that the LP, when it collects revenue or withdraws liquidity, only redeems fees accrued since the time of the liquidity add. According to an embodiment, the value of the last_revenue_claim field of a given NFT j at step n may be denoted by rⱼ(n). It should be noted that, in an implementation, these values may not tracked by the pool because they are stored in the corresponding NFT itself.

### Example TBC Initialization

According to an aspect, when a pool is initialized, state variables may be defined as described in Table 1, described hereinabove. An amount x_{add} of tokens may also be deposited into the pool. In an embodiment, an initial value for area under the TBC curve before the n^{th} transaction may be established according to example equation (2) below:

$${D}_{0} = D ( {x}_{min}^{( 0 )} , b ( 0 , {C}_{0} , {V}_{0} ) , {p}_{lower} ) . \qquad ( 2 )$$

In an implementation, two example NFTs may be be minted and given to the pool deployer upon initialization of the pool.

The first example NFT may have its amount field value equal to

$${W}_{0} - {W}_{0}^{I}$$

and its last_revenue_claim field value equal to D₀. Such an NFT may be represented as:

$$NFT ( \{ amount : {W}_{0} - {W}_{0}^{I} , last\_revenue \_claim : {D}_{0} \} ) . \qquad ( 3 )$$

The second example NFT, which may be referred to herein as an “inactive-fee” NFT (and is unique in this way), may have its amount field value equal to

$${W}_{0}^{I}$$

and its last_revenue_claim field value equal to ∞. An inactive-fee NFT may be represented as:

$$NFT ( \{ amount : {W}_{0}^{I} , last\_revenue \_claim : ∞ \} ) . \qquad ( 4 )$$

It should be noted that, in an embodiment, ∞ can be replaced by any appropriate number or object that correctly handles the following non-limiting example actions for an inactive-fee NFT:
a) Extracting revenue: the transaction should be immediately reverted.
b) Withdrawing liquidity: the transaction is allowed with some modifications.
c) Adding liquidity: the transaction should be immediately reverted.

### Example Liquidity Additions and Withdrawals

According to an aspect, an example ALTBC may be deployed as a general-purpose pricing mechanism.

In an embodiment, to add liquidity, the ratio of assets proposed by a prospective LP may be considered. A given ALTBC state may imply a ratio of one asset to the other asset. For example, if the price of 1 X token is 10 Y token, a liquidity add in the amounts of 10 Y token and 1 X token would be exactly proportional.

An example embodiment may be configured to accept proportional liquidity additions. In an implementation, when an LP offers tokens in quantities that are out of proportion, the pool may determine proportional amounts, and return the difference to the LP.

### Example Liquidity Position and Pool Ownership Tracking

An example embodiment may provide a mechanism for tracking pool ownership to facilitate the introduction of liquidity positions. As discussed hereinabove, this may be achieved by issuing NFTs that track the value of a given liquidity position and the cumulative amount of value so far redeemed by a given NFT owner.

### Example Liquidity Add Workflow

Table 6 below describes non-limiting example steps for a liquidity add workflow according to an embodiment.

Liquidity Add Flow

| Step | Description |
|---|---|
| 1 | Liquidity Provider submits a call to the ALTBC to add liquidity |
| | amounts in quantities A and B. |
| 2 | The ALTBC adjusts A and B to be in the correct proportion (A*, |
| | B*), returning the unused portions of the submitted amounts to |
| | the LP. |
| 3 | A* and B* are added to the pool. |
| 4 | The ALTBC state changes to reflect these additions. |
| 5 | An NFT is minted to the Liquidity Provider (or updated, if an |
| | existing NFT is provided) indicating the value of the created |
| | position. |

Table 6: Example liquidity add workflow according to an embodiment.

### Example Pool Ownership and Revenue Extraction

In an implementation, the existence of LP tokens (e.g., NFTs) may imply that ownership of a pool is shared among LPs, where the amount of value stored in a given NFT represents the portion of the entire pool that belongs to the NFT owner. Holders of these NFTs, therefore, can use them to pull liquidity from the pool and/or to distribute accumulated excess capital from the pool to LPs.

According to an aspect, for liquidity removal, an LP can pull out the amount of liquidity originally added, along with fees accrued since the time the liquidity position was opened (using the last_revenue_claim quantity). In an embodiment, the withdrawal function may pay the LP with asset amounts in a proportion implied by a current state of an ALTBC.

### Example Excess Capital Extraction

As discussed hereinabove, in an embodiment, for a given X token value, collateral may accrue (e.g., continually accrue) to market owner(s) upon the completion of transactions. This property of an example embodiment may be referred to herein as the monotonicity of spot price for a given supply value; further discussion of monotonicity of spot price is provided hereinbelow. According to an aspect, most of the accrued collateral may be utilized to supply liquidity for trades in a reachable domain of an ALTBC, i.e., the domain of xₘᵢₙ≤x≤xₘₐₓ. But some of the increased collateral may be inaccessible to traders. That is, even if all available X token were sold back to traders, some collateral would remain.

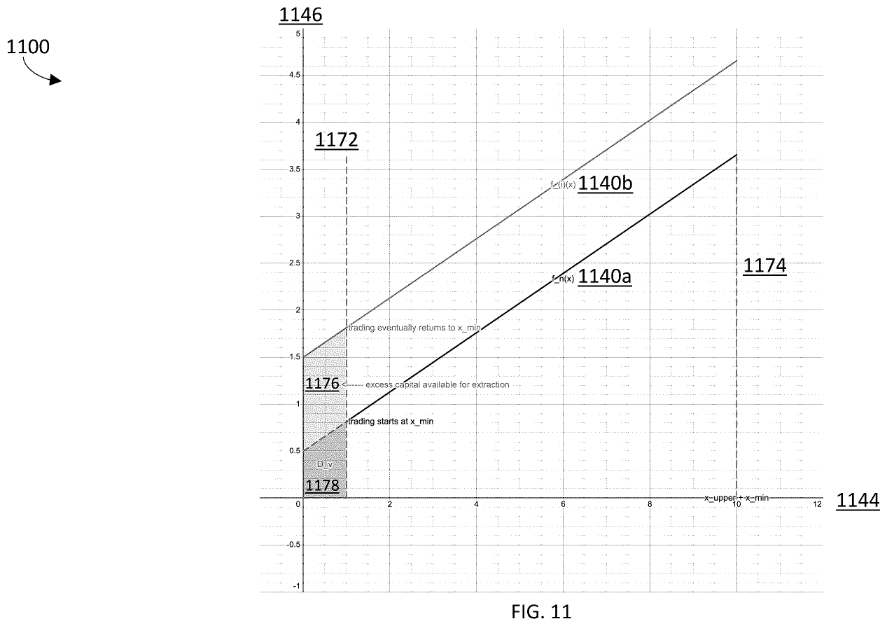

FIG. 11 is a graph 1100 illustrating an example of excess capital accruing at x-values below xₘᵢₙ according to an embodiment. The graph 1100 has axes of x values 1144 and y values 1146. An initial price function 1140a for an ALTBC may be denoted as fₙ(x). In an implementation, trading may begin at line 1172 where x=xₘᵢₙ, after which some trading occurs, followed by a large selloff that causes trading to eventually return to line 1172. This activity may result in a new price curve 1140b for the ALTBC that is higher than 1140a and may be denoted by fᵢ(x). Much of the accumulated collateral may have been issued back to traders during the selloff, but an amount 1176 may remain even after the last token has been sold back to the market. According to an aspect, this amount 1176 may become the property of market owner(s). In an embodiment, this excess value 1176 may be available to the market owner(s) via an example revenue function.

Continuing with FIG. 11, in an implementation, the quantity 1176 may be shared by market owners (e.g., LPs) in amounts corresponding to the their respective NFTs. According to an embodiment, LP NFTs may also track the cumulative amount of revenue paid out to LP position holders. This may allow the position holders to redeem the amounts they own. Table 7 below shows non-limiting example information that may be stored by an LP NFT.

TABLE 7
Example LP NFT fields according to an embodiment.

| Field | Meaning |
|---|---|
| token_id | Unique identifier for the LP NFT. |
| amount | Represents the portion of liquidity ownership |
| | associated with this NFT. |
| last_revenue_claim | Ensures the correct amount of excess capital is |
| | paid out to NFT holder. |

### Example Liquidity Withdrawal

To provide for an LP to withdraw a portion of the liquidity stored in an LP NFT, an example embodiment may perform the following non-limiting example steps:
a) Amounts of X token and Y token corresponding to the value of the NFT are issued to the LP.
b) An amount of excess capital belonging to the LP is issued to the LP.
   i. According to an aspect, this amount may be based at least in part on the cumulative amount of revenue paid out to the LP.
c) An ALTBC state is updated to reflect the resulting change.

Further details of example liquidity withdrawals are provided hereinbelow.

As discussed hereinabove, in an implementation, LPs can use their LP NFTs to redeem value by performing either of two different example functions: withdrawing the liquidity the LPs originally added, or redeeming the amount of excess collateral to which their LP position entitles them.

These two example functions may be separate, but related. For instance, an LP can request a revenue payout (i.e., redeem excess collateral) without withdrawing any liquidity, but a liquidity pull may automatically trigger a proportional revenue payout. In the case of either example function, in an implementation, when revenue is paid out, the corresponding LP NFT may be updated (in the last_revenue_claim field) so that the LP cannot redeem more revenue than is owed.

### Example Pricing Curve Interpretation

Described hereinbelow are example interpretations of variables stored in an ALTBC according to an embodiment.

With respect to xₙ, in conventional TBC-space, the x-axis may represent the total number of tokens minted by the TBC. However, for an example ALTBC according to an embodiment that accepts external liquidity changes (i.e., liquidity additions and withdrawals), xₙ may not represent total circulating supply. Instead, xₙ may be an amount of x-token that can be utilized to drain a pool of all its collateral.

According to an aspect, example variable x_{add} (which may be user-supplied) may represent the initial maximum number of tokens for sale by an ALTBC. However, in an implementation, x_{add} may not be the highest value that xₙ can reach. According to an embodiment, because an example reachable trading region may be offset by the presence of xₘᵢₙ, the highest reachable x-value may instead be xₘₐₓ, which is the sum of xₘᵢₙ and x_{add}.

In an embodiment, the value of xₘₐₓ may be subject to change with the addition of new liquidity. For instance, when an LP adds liquidity to a pool, an increased value of xₘₐₓ may represent the fact that more X token is available for sale (and, correspondingly, more Y token is held as collateral).

### Example Initial ALTBC Parameter Settings

Various example parameters used to initialize an ALTBC, and example parameters updated by an ALTBC over time, are discussed hereinabove. To facilitate the selection of reasonable initial values, an embodiment may allow a user to specify easily interpretable values, including the below non-limiting example variables:
a) l: a multiple of an initial price amount.
b) Q: a cost or penalty imposed on a malicious actor for driving the initial price up by a factor of l. (Further discussion of example penalty values is provided hereinbelow.)
c) T_target: a certain number of tokens to sell, such that item (d) is true, i.e., that the price of the asset has reached p_target.
d) p_target: a minimum price of the asset after T_target tokens have been purchased.

When a user has specified the above example variables (a)-(d), an embodiment may then determine appropriate values of internal variables for initialization of an ALTBC. Further discussion of these example variables (a)-(d), and how they may be used to compute internal parameters of an ALTBC, is provided hereinbelow.

### Example ALTBC Advantages and Properties

Described hereinbelow are example advantages and notable properties of ALTBCs.

### Directional Consistency of Spot Price

In an embodiment, a price rule may change as traders buy and sell over time. For instance, the slope of the pricing curve may decrease as circulating supply increases. Nonetheless, an example embodiment may preserve the law of supply and demand by causing the price to increase with buy trades, and decrease with sell trades.

### Example Inherent Price Stability

According to an aspect, as x values go up, the slope a pricing curve may decrease. The price impact of a given trade may thus become smaller as more X token is circulated. It should be noted that the behavior of this contour (i.e., volatility decreases as more X token is in supply) is the opposite of an existing Uniswap pool. Further discussion of inherent price stability is provided hereinbelow.

### Example Price and Collateral Monotonicity

An example embodiment may ensure that price and collateral are monotonic at a given x-value. For instance, when an embodiment has minted 100 tokens at transaction #1 and the current price f(x) is 200, the arrival of transactions #2, #3, and #4 for a buy of 10, a sale of 15, and a buy of 5, respectively, may cause the x-value to trace the path 100→110→95→100, i.e., a roundtrip that returns to the initial value of 100. The property of price and collateral monotonicity may cause both values to be higher at example transaction #4 than at transaction #1.

### Example Innate Mitigation of MEV Sandwich Attacks

An MEV sandwich attack operates by “sandwiching” a given target trade with two trades designed by a malicious actor. The first trade drives the price up. After the first trade, the “sandwiched” trade settles at a less favorable price than anticipated. The attacker then sells at a better price than the purchase price of the first trade, thereby profiting from the difference at the sandwiched trader's expense.

An example embodiment can establish an upper bound on the profitability of sandwich attacks. In an implementation, the price stability of an example embodiment, along with its collateral preservation property, may limit the range of viable sandwich attack sizes, so that only a finite range are profitable for a given target trade. An illustration of example innate mitigation of sandwich attacks is provided hereinbelow.

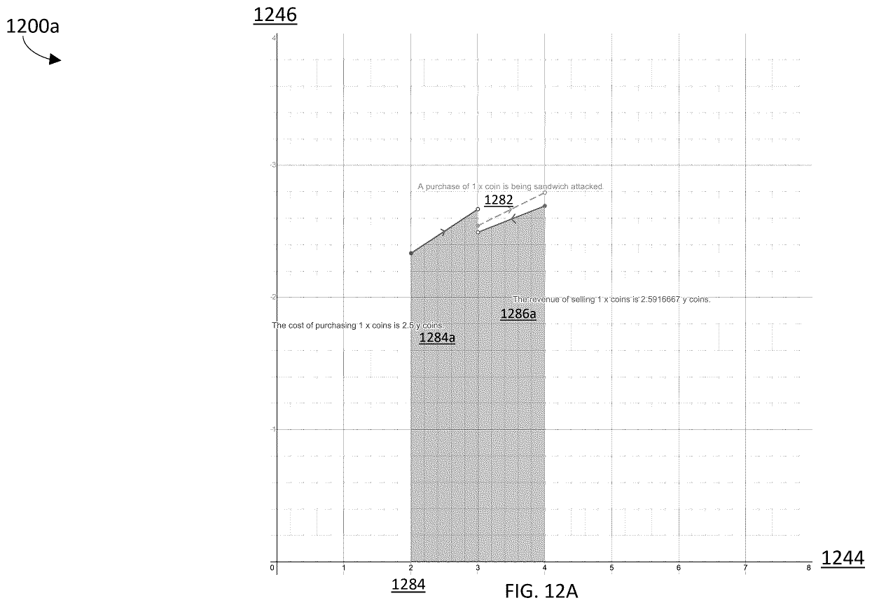

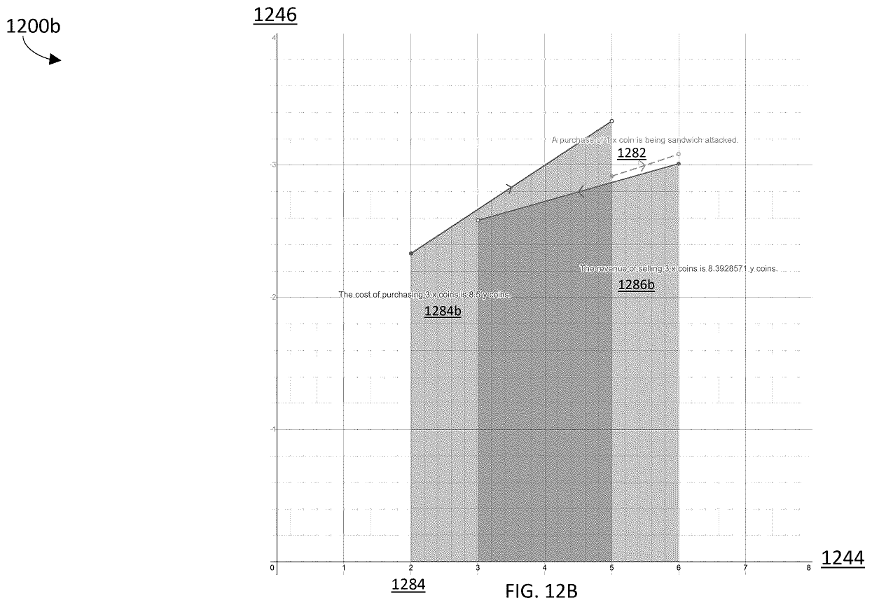

FIG. 12A is a graph 1200a illustrating an example sandwich attack of size 1 against a target trade 1282 of size 1, with a starting supply 1284 of 2, and other ALTBC parameters kept constant. The graph 1200a has axes of x values 1244 and y values 1246. As shown in FIG. 12A, purchasing 1 X token has a cost 1284a of 2.5 Y tokens, while selling the 1 X token generates revenue 1286a of 2.5916667 Y tokens. This results in a gain of 0.0916667 Y tokens, thus making the sandwich attack of size 1 profitable.

FIG. 12B is a graph 1200b illustrating an example sandwich attack of size 3 against a target trade 1282 of size 1, with a starting supply 1284 of 2, and other ALTBC parameters kept constant. The graph 1200b has axes of x values 1244 and y values 1246. As shown in FIG. 12B, purchasing 3 X tokens has a cost 1284b of 8.5 Y tokens, while selling the 3 tokens generates revenue 1286b of 8.3928571 Y tokens. This results in a loss of −0.1071429 Y tokens, thus making the sandwich attack of size 3 unprofitable.

To give an illustrative example, a target trade with a size of 1 X token coin may be subject to a sandwich attack and an initial x-value of an ALTBC may be 2, with various other internal parameters of the ALTBC held constant.

An attacker in the example scenario may then specify a magnitude S of the sandwich attack designed to extract as much profit as possible, i.e., to maximize the difference between the initial purchase price for S tokens and the subsequent sale revenue for S tokens (with the sale price being greater). In the ALTBC, some S values will yield profits, as shown for example in FIG. 12A. However, if the sandwich size is too large, the sandwich attack will produce a loss, as shown for example in FIG. 12B.

Innate mitigation of sandwich attacks is an example of the powerful advantages that embodiments offer compared to conventional liquidity solutions.

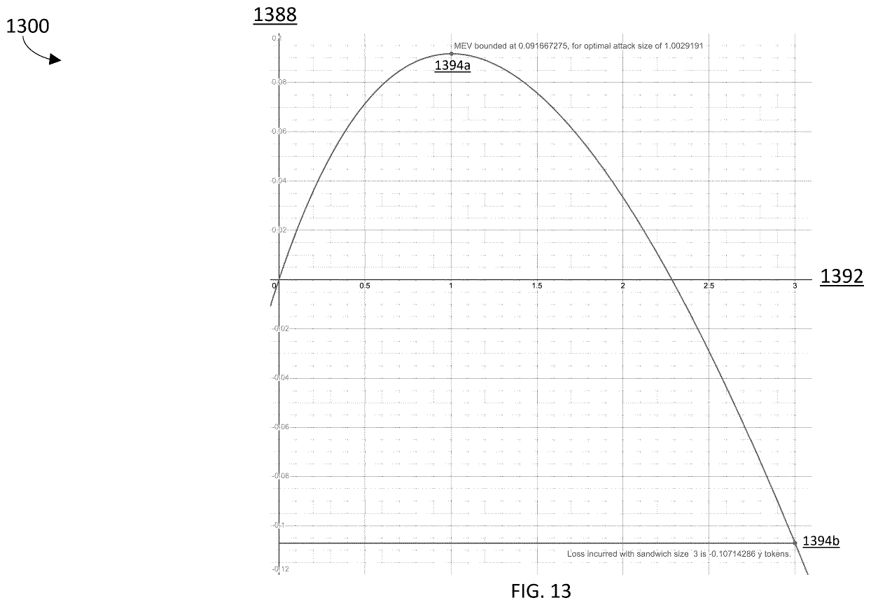

FIG. 13 is a graph 1300 illustrating MEV 1388 as a function of sandwich attack size 1392, with a specified target trade size and ALTBC parameters kept constant. As shown in FIG. 13, an attack 1394a size 1.0029191 is maximally profitable with an MEV 1388 of 0.091667275, whereas an attack 1394b size 3 yields a loss with an MEV 1388 of −0.10714286.

It should be noted that in the case of the existing Uniswap V2 pool, MEV is mathematically unbounded. In an example embodiment, however, there is an upper limit on how much a sandwich attacker can earn, even before considering fees and slippage tolerances. FIG. 13 clearly shows this upper bound by plotting the attacker's profit and loss 1388 as a function of sandwich attack size 1392. An example derivation of MEV as a function of attack size is provided hereinbelow.

### Example Bounded Incentive for Trade-Splitting

In an embodiment, the slope of the price curve may decrease as circulating supply increases. A consequence of this property may be that, for a given trade, it may be desirable for a trader to split that order into many smaller orders. In this way, an example embodiment may determine a balance between relative degrees of so-called “size consistency” on the one hand and flexibility, price stability, security against MEV attacks, and profitability, on the other hand. Provided hereinbelow is a discussion of an example bounds on trade splitting provided by an embodiment.

To give an illustrative example, an order of a fixed size may be partitioned into n separate orders. As the number of sub-orders n grows, the number of times the slope of the price curve decreases may also grow. The price updates from the decreases in slope may represent an improvement, from the trader's perspective, compared to having a smaller number of sub-orders n. It may thus be optimal for the trader to partition orders into infinitely many sub-orders—because this may lead to the lowest spot price. Such infinite splitting may result in an optimal curve that represents the best achievable price for a given order size, from a given supply starting point. As discussed hereinabove, the best-achievable prices may constitute a limiting TBC.

In an implementation, an optimal curve (or, alternatively, a limiting TBC) that represents the best achievable price for a given trade, based on infinite trade splitting, may be expressed in the following example form:

$${p}_{0} + \frac{1}{2} ( \frac{x}{x + C} - \frac{{x}_{0}}{{x}_{0} + C} ) + \frac{1}{2} ln ( \frac{x + C}{{x}_{0} + C} )$$

where p₀ is the spot price, x₀ is the current supply, and x is the subsequent supply value (i.e., the supply value resulting from a subsequent buy or sell trade for |x−x₀| amount of X token).

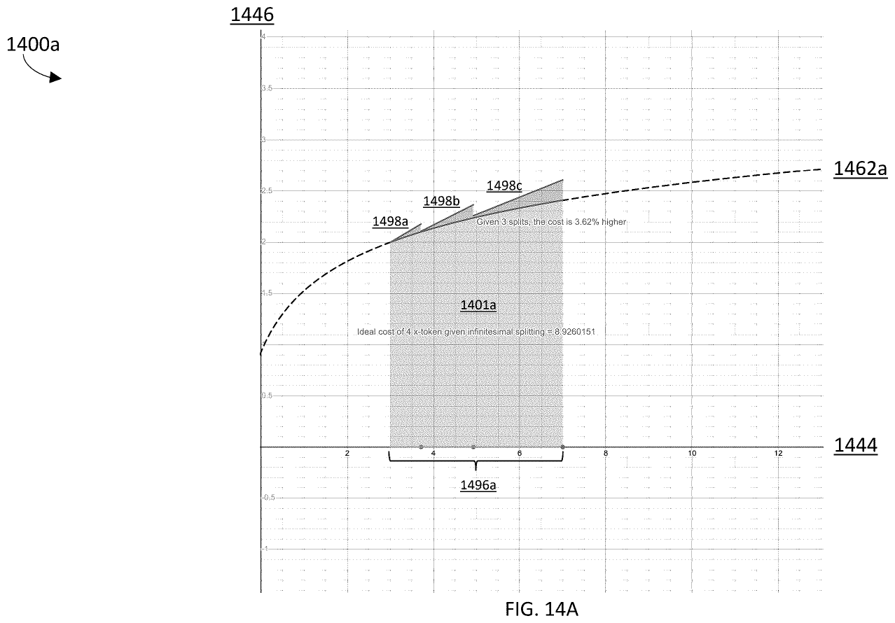

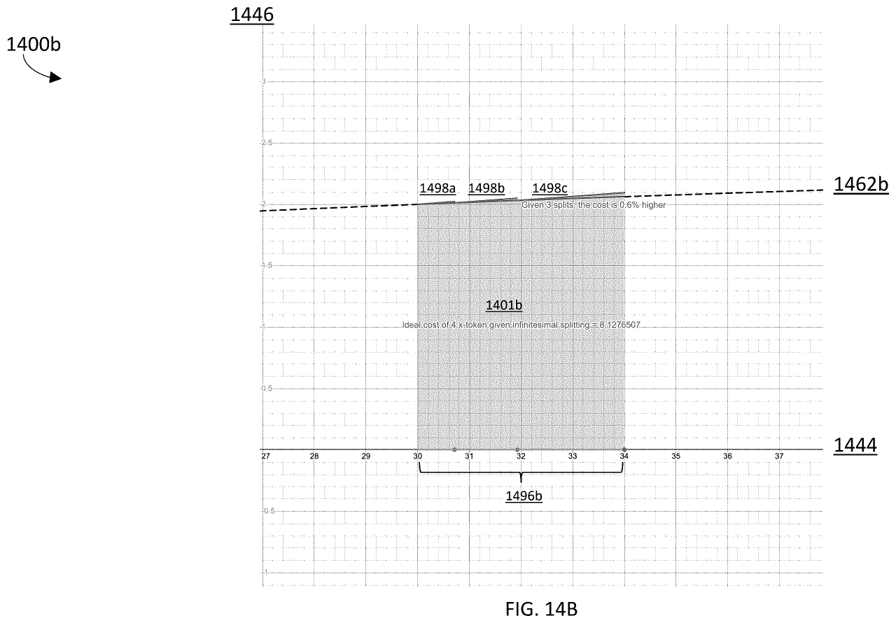

FIG. 14A is a graph 1400a illustrating example partitioning for an order 1496a of size 4 (i.e., 3→7) in a setting with a low supply of 3. The graph 1400a has axes of x values 1444 and y values 1446. As shown in FIG. 14A, using three partitions 1496a-1496c may lead to a price that, as indicated by corresponding shaded areas, is 3.62% higher than an optimal price of 8.9260151, as indicated by shaded area 1401a under optimal curve 1462a.

FIG. 14B is a graph 1400b illustrating example partitioning for an order 1496b of size 4 (i.e., 30→34) in a setting with a supply of 30, which is higher than that of FIG. 14A. The graph 1400b has axes of x values 1444 and y values 1446. As shown in FIG. 14B, after using the three partitions 1496a-1496c, the price, as indicated by corresponding shaded areas, is only 0.6% higher and thus already close to the optimal price of 8.1276507, as indicated by shaded area 1401b under optimal curve 1462b.

It should be noted that, in an embodiment, an optimal curve (e.g., 1462a or 1462b) may not be an ALTBC. The optimal curve may represent an ideal price for a given order size, from the reference point of a single supply position. In practice, a given trade may move an ALTBC up or down a given fₙ(x) price function, which may produce different results from the optimal curves 1462a and 1462b shown in FIGS. 14A and 14B, respectively.

In practice, the incentive to split may vary depending on the number of partitions n, and the starting supply position x from which a given partitioned trade is initiated. As n grows, the difference between the optimal price and the obtained price may decrease. This difference may be referred to herein as the incentive to split. However, it should be noted that this difference also decreases as x grows.

FIGS. 14A and 14B show the above effect when using an example fixed partition size of 3. In FIG. 14A, the partition strategy operates in a relatively low supply situation (initial x=3). The three example partitions 1496a-1496c yield a realized price that is 3.62% higher than the ideal price 1401a. In this scenario, traders may desire to control how many order partitions they are allowed, and the incentive to split is greater.

FIG. 14B, in contrast, depicts a higher supply situation (initial x=30). In FIG. 14B, the same partition strategy 1496a-1496c achieves an outcome that is much closer to the optimal price 1401b. As supply increases, traders may thus have less desire to optimize their order partitions, and the incentive to split will be weaker.

In view of the discussion hereinabove, the incentive to split may only apply in relatively low-supply settings. Even in those settings, however, traders may in fact be unlikely to deploy complex partition schemes. This is because such schemes may require time and deliberation, and because at lower supply, the volatility of the asset may be highest. Given the higher price volatility and greater competition in the low supply setting, the risk of destructive levels of partition optimization may be relatively low.

It should be noted that, while an optimal curve may be achievable with uniform infinite order splitting, the order sizes are non-uniform for a given number of partitions. This non-uniformity is illustrated by the uneven sizes of the partitioned orders 1496a-1496c in FIGS. 14A and 14B. Attackers desiring to achieve optimal order partitioning may also face a non-trivial numerical analysis problem due to this non-uniformity. Moreover, the attackers may have to determine a solution to such a problem rapidly in a demanding environment where assets are traded in low-supply circumstances. This analytical obstacle is an example of a factor that may make it less likely to achieve optimal splitting in practice. While sandwich attackers can still make gains with suboptimal partitions, systematically partitioning orders may nonetheless be inefficient and burdensome, particularly in the early stages of an asset's lifecycle. The analytical obstacle may also be especially pertinent in low-supply settings, where partitioning schemes may be most relevant, because fewer X tokens are available to meet traders' demands.

It should be noted that the analysis hereinabove makes no assumptions regarding fees or rules, e.g., protocol fees and ecosystem rules. The incentive to split may be significantly mitigated by gas fees alone. Moreover, rules imposing caps on order frequency per address, or a minimum allowable trade size, may also remove this incentive altogether.

### Example Initial Supply Value

By providing a minimum x-value, that is, xₘᵢₙ, greater than 0, an example embodiment may ensure that prices cannot be costlessly manipulated by malicious traders. Put differently, in a scenario where malicious traders can reduce outstanding supply to 0, a high volume of roundtrips to and from x=0 may repeatedly drive up the price, without costing traders anything (aside from transaction fees). While the malicious traders may not profit directly from such trades, the traders may benefit from sabotaging the price mechanism by increasing the price artificially.

An example embodiment may utilize xₘᵢₙ to impose a cost on such roundtrips, so that a malicious trader seeking to inflate prices early in an ALTBC's lifecycle will incur a penalty to do so. In an implementation, the penalty for generating price inflation may vary depending on the value of xₘᵢₙ.

In an implementation, a value of xₘᵢₙ may be considered as a percentage of x_{add}, which may be denoted by the variable k. Provided hereinbelow is a discussion of how an example ALTBC's behavior may change with different values of k.

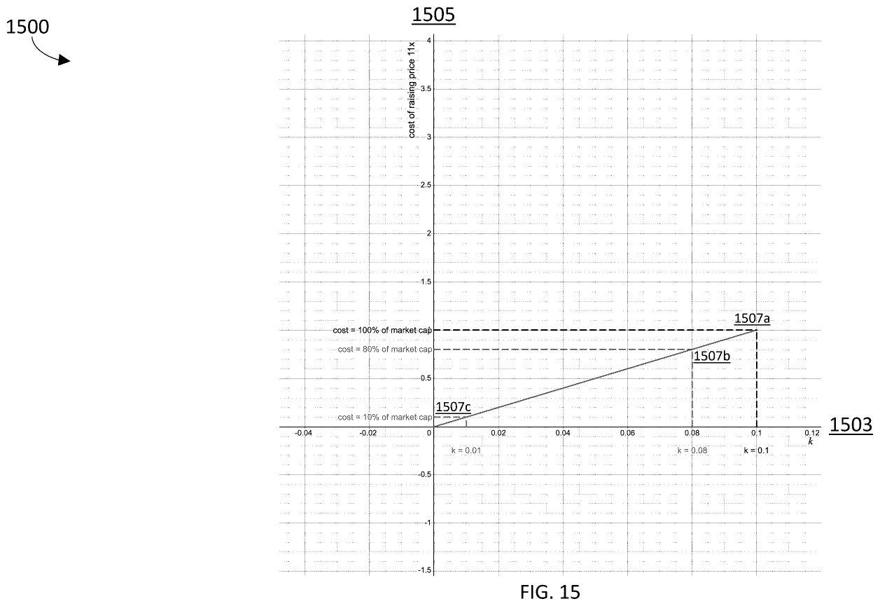

FIG. 15 is a graph 1500 illustrating example costs 1505 to malicious traders of driving up a price by a factor of 11 as a function of k sizes 1503; other known factor values are also suitable. In an embodiment, the costs 1505 may be measured as a percentage of market capitalization, which may be defined as the lowest price on a starting ALTBC multiplied by x_{add}. As shown in FIG. 15, to drive up the price to 11× its initial value, with a k size 1503 of 0.1, it would cost 1505 a trader 100% of market capitalization at point 1507a; with a k size 1503 of 0.08, driving up the price would cost 1505 a trader 80% of market capitalization at point 1507b; and with a k size 1503 of 0.01, driving up the price would cost 1505 a trader 10% of market capitalization at point 1507c.

As shown in FIG. 15, in an embodiment, the variable k may be used to specify a tradeoff. On the one hand, higher values of k may impose higher costs on a malicious trader seeking to drive up prices. On the other hand, higher values of k may reduce the market's flexibility.

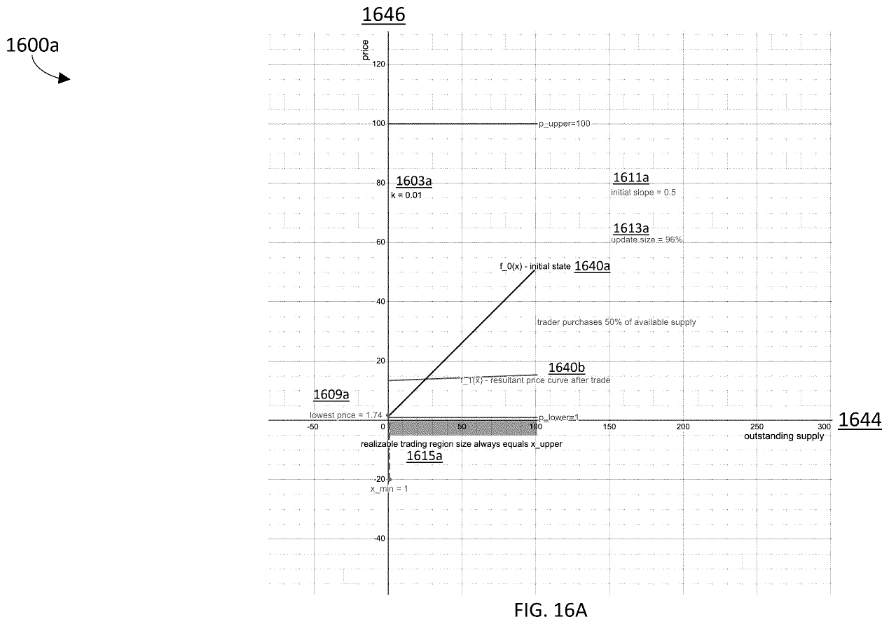

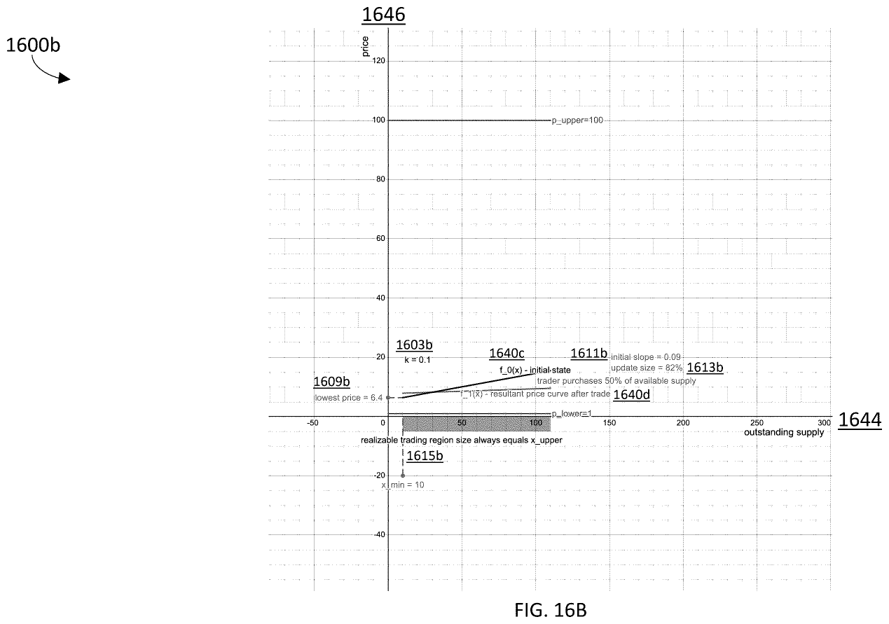

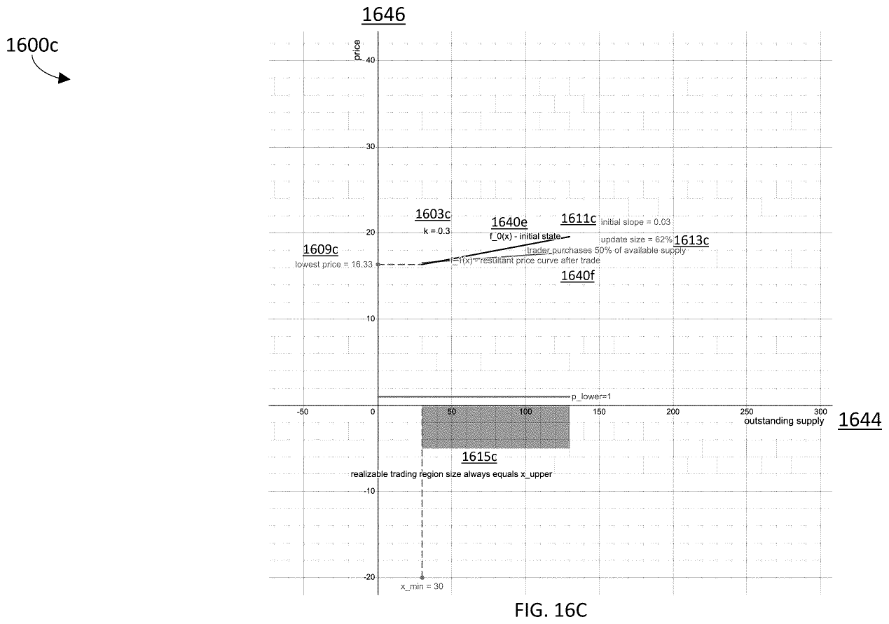

FIGS. 16A-16C illustrate example effects of higher k values on market flexibility.

FIG. 16A is a graph 1600a illustrating example prices 1646 as a function of outstanding supply 1644 when buying 50% of available supply with a k size 1603a of 0.01. As shown in FIG. 16A, the low k value 1603a results in a lower initial spot price 1609a, a higher initial slope 1611a, and a more significant update 1613a from price curve 1640a to 1640b. Shading indicates a realizable trading region 1615a.

FIG. 16B is a graph 1600b illustrating example prices 1646 as a function of outstanding supply 1644 when buying 50% of available supply with a k size 1603b of 0.1. As shown in FIG. 16B, the higher k value 1603b results in a higher initial spot price 1609b, a lower initial slope 1611b, and a less significant update 1613b from price curve 1640c to 1640d after the same trade. Shading indicates a realizable trading region 1615b.

FIG. 16C is a graph 1600c illustrating example prices 1646 as a function of outstanding supply 1644 when buying 50% of available supply with a k size 1603c of 0.3. As shown in FIG. 16C, the high k value 1603c results in a high initial spot price 1609c, a low initial slope 1611c, and a less significant update 1613c from price curve 1640e to 1640f after the same trade. Shading indicates a realizable trading region 1615c.

A higher k value may cause an increase in the minimum achievable price. Moreover, a higher k value may lead to a lower initial slope value at the beginning of an ALTBC's lifespan, thus causing prices to move less initially. A higher k value may also result in smaller sizes of updates to an ALTBC. These three example effects are shown in FIGS. 16A-16C by three example measures of an ALTBC's flexibility: initial price 1609a-1609c, initial slope 1611a-1611c, and update size 1613a-1613c (the latter of which may be measured as a percent change in slope from one curve to the other). FIGS. 16A-16C show that initial price 1609a-1609c goes up, while initial slope 1611a-1611c and update size 1613a-1613c go down, with increases to k size 1603a-1603c. It should also be noted that the realizable trading region 1615a-1615c is shifted to the right, but its size stays the same. Put differently, a high k value does not cause a decrease in the total number of tokens for sale, because that value that is stored as x_{add}.

### Example Experimental Results

Described hereinbelow are example experimental results, using real-world trade data to compare example embodiments with Uniswap pools.

### Example Experimental Setup

It should be noted that the results described hereinbelow were generated using the following example experimental setup:
a) The raw data represent actual buys and sells executed on Uniswap pools (both V2 and V3). These trades took place in the context of actual historical market prices, which differ from the price sequences generated by an example embodiment. Because prices affect demand, different trade sequences may occur in an environment where an example embodiment alone is setting prices. In the example experiments, however, demand was held constant irrespective of price.
b) An example embodiment can be parameterized in various ways, which may lead to different price behaviors. Example parameter values were chosen for the experiments that yielded instructive results. The parameters used are explained in further detail hereinbelow.
c) To accommodate the sequences of trades in the real-world data, an example embodiment was initialized and then run for a large initial purchase to prevent the x value from reaching 0 and blocking some of the trades in the datasets.

### Discussion of Example Results

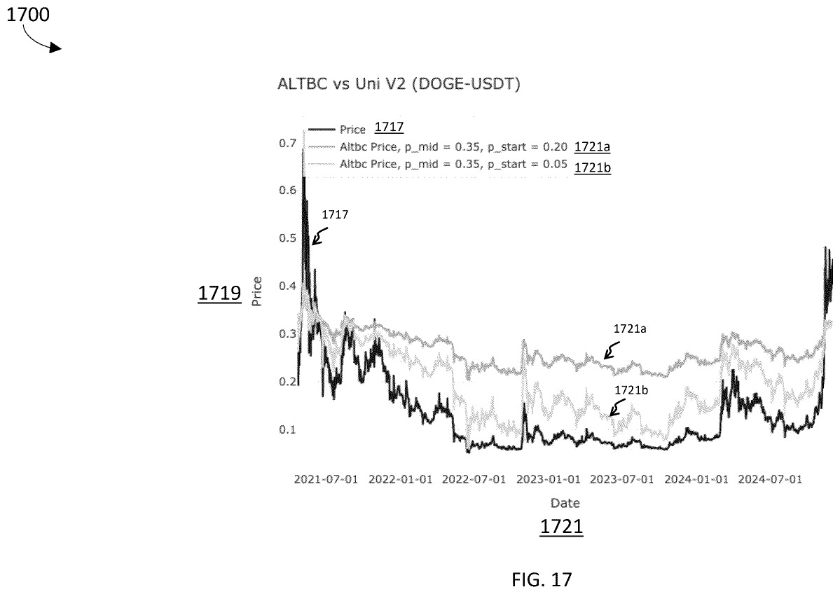

FIG. 17 is a plot 1700 comparing example embodiments and an existing Uniswap V2 pool 1717 on the Dogecoin-Tether (DOGE-USDT) trading pair. The plot 1700 depicts prices 1719 over time 1721 for the Uniswap pool 1717 and example embodiments 1721a and 1721b with a mid price (p_mid) of 0.35 and a starting price (p_start) of 0.20 and 0.05, respectively.

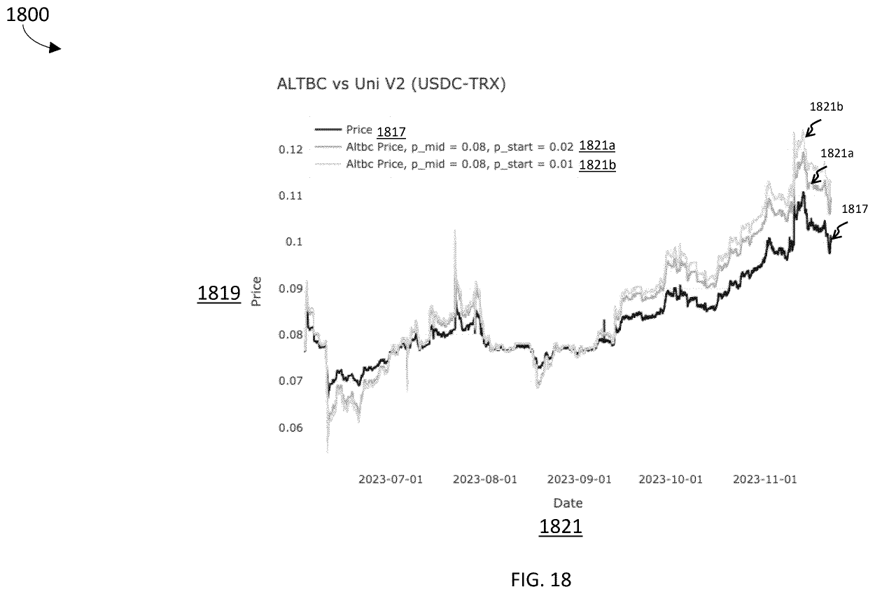

FIG. 18 is a plot 1800 comparing example embodiments and an existing Uniswap V2 pool 1817 on the Tronix-Circle (TRX-USDC) trading pair. The plot 1800 depicts prices 1819 over time 1821 for the Uniswap pool 1817 and example embodiments 1821a and 1821b with p_mid of 0.08 and p_start of 0.02 and 0.01, respectively.

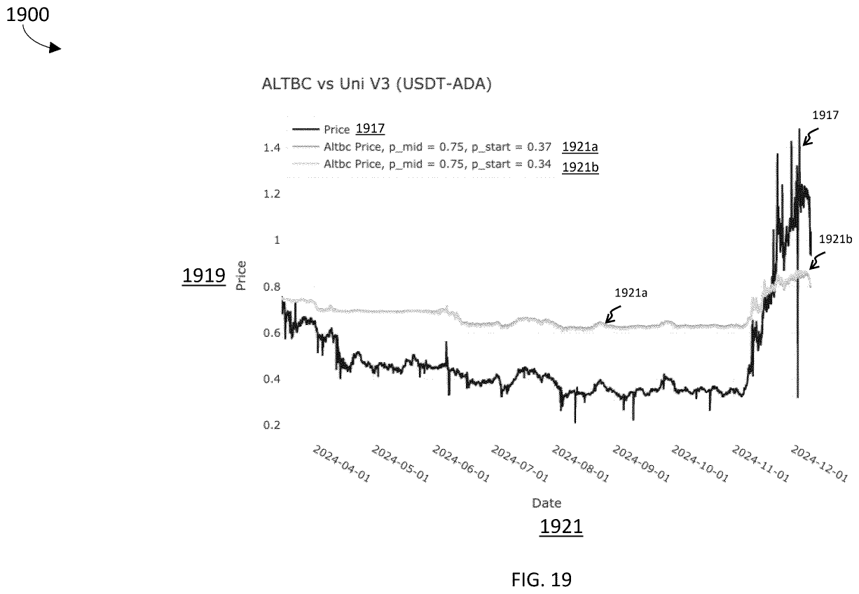

FIG. 19 is a plot 1900 comparing an example embodiment and an existing Uniswap V3 pool 1917 on the Cardano-Tether (ADA-USDT) trading pair. The plot 1900 depicts prices 1919 over time 1921 for the Uniswap pool 1917 and example embodiments 1921a and 1921b with p_mid of 0.75 and p_start of 0.37 and 0.34, respectively.

Among other things, FIGS. 17-19 demonstrate the following:
a) Whereas Uniswap V2 pools (e.g., 1717 and 1817) require an initial deposit of collateral, example embodiments (e.g., 1721a-1721b and 1821a-1821b) can achieve similar price movement without requiring any initial collateral allotment.
b) Whereas Uniswap V3 pools (e.g., 1917) require active management, example embodiments (e.g., 1921a-1921b) can achieve similar price movements without any active management.
c) An example embodiment may provide inherent price stability, unlike Uniswap.
d) The p_mid variable may influence price stability, with higher values leading to greater volatility.
e) When volume is high, but buys and sells roughly cancel each other out in the aggregate, price and collateral may move upward steadily.
f) For tokens that trade in the $1 range, an example embodiment may provide an advantageous combination of bootstrapping utility and price discovery.

### Example Formal Description of ALTBC Trading and Price Impact

### Example Initial State

In an implementation, x₀ may be an amount of tokens sold by an example protocol.

A linear token bonding curve may be defined by the following example equation:

$$f ( x ) = {b}_{0} x + {c}_{0}$$

where b₀, c₀>0.

A slope field may be defined by the following example equation:

$$s ( x ) = \frac{V}{x + {Γ}_{0}}$$

A cost function may be defined by the following example equation:

$$F ( x ) = \frac{1}{2} {b}_{0} {x}^{2} + {c}_{0} x$$

An amount of collateral in a pool may be defined as F(x₀).

### Example Trade

In an embodiment, a trader may buy or sell an amount a of tokens. When a>0, this may indicate that the trader is buying a tokens, and when a<0, this may indicate that the trader is selling −a tokens. In either such case, the amount of tokens sold by an example protocol after the trade may be defined by the following equation:

$${x}_{1} = {x}_{0} + a$$

The amount of collateral either paid or received by the trader may be given by the following example equation:

$$Δ = F ( {x}_{1} ) - F ( {x}_{0} )$$

In the above example equation, if Δ>0, then the trader may pay that amount and the collateral in a pool may increase (that is, F(x₁)>F(x₀)), and if this amount is negative, then the trader may receive an amount −Δ of collateral and the amount of collateral in the pool may decrease (that is, F(x₁)<F(x₀)).

It should be noted that, when F is a strictly increasing function, this may result in the following example relationship:

$$Δ > 0 ⇔ F ( {x}_{1} ) > F ( {x}_{0} ) ⇔ {x}_{1} > {x}_{0} ⇔ a > 0$$

### Example State After Trade

According to an aspect, after a trade, an amount of tokens sold by an example protocol may be defined by the following equation:

$${x}_{1} = {x}_{0} + a$$

The parameters b and c of a linear token bonding curve may be updated according to the following example equations:

$${b}_{1} = \frac{V}{{x}_{1} + {Γ}_{0}}$$

$${c}_{1} = \frac{F ( {x}_{1} ) - \frac{1}{2} {b}_{1} {x}_{1}^{2}}{{x}_{1}} = \frac{\frac{1}{2} {b}_{0} {x}_{1}^{2} + {c}_{0} {x}_{1} - \frac{1}{2} {b}_{1} {x}_{1}^{2}}{{x}_{1}} = \frac{1}{2} ( {b}_{0} - {b}_{1} ) {x}_{1} + {c}_{0}$$

The linear token bonding curve itself may thus be updated according to the following example equation:

$${f}_{1} ( x ) = {b}_{1} x + {c}_{1}$$

An amount of collateral in a pool after the trade may be defined by the following example equation:

$$F ( {x}_{1} ) = \frac{1}{2} {b}_{0} {x}_{1}^{2} + {c}_{0} {x}_{1}$$

A cost function may be updated according to the following example equation:

$${F}_{1} ( x ) = \frac{1}{2} {b}_{1} {x}^{2} + {c}_{1} x$$

In an embodiment, if the updated cost function is utilized to compute the amount of collateral in the pool after the trade, the resulting amount may be F₁(x₁). Using the example definitions of the updated parameters described hereinabove, this may result in the following:

$${F}_{1} ( {x}_{1} ) = \frac{1}{2} {b}_{1} {x}_{1}^{2} + {c}_{1} {x}_{1} = \frac{1}{2} {b}_{1} {x}_{1}^{2} + ( \frac{1}{2} ( {b}_{0} - {b}_{1} ) {x}_{1} + {c}_{0} ) {x}_{1} = \frac{1}{2} {b}_{1} {x}_{1}^{2} + \frac{1}{2} {b}_{0} {x}_{1}^{2} - \frac{1}{2} {b}_{1} {x}_{1}^{2} + {c}_{0} {x}_{1} == \frac{1}{2} {b}_{0} {x}_{1}^{2} + {c}_{0} {x}_{1} = F ( {x}_{1} )$$

### Example Price Impact of Trade

In an implementation, price impact of a trade may be defined by the following example equation:

$$\frac{\vert effective price of the trade - spot price before the trade \vert}{spot price before the trade}$$

The price impact may be further defined by the following example equations:

$$\begin{matrix}Price Impact = \vert \frac{\frac{F ( {x}_{1} ) - F ( {x}_{0} )}{a} - ( {b}_{0} {x}_{0} + {c}_{0} )}{{b}_{0} {x}_{0} + {c}_{0}} \vert = \vert \frac{F ( {x}_{1} ) - F ( {x}_{0} )}{a ( {b}_{0} {x}_{0} + {c}_{0} )} - 1 \vert = \\ = \vert \frac{\frac{1}{2} {b}_{0} {x}_{1}^{2} + {c}_{0} {x}_{1} - ( \frac{1}{2} {b}_{0} {x}_{0}^{2} + {c}_{0} {x}_{0} )}{a ( {b}_{0} {x}_{0} + {c}_{0} )} - 1 \vert = \\ \vert \frac{\frac{1}{2} {b}_{0} ( {x}_{1}^{2} - {x}_{0}^{2} ) + {c}_{0} ( {x}_{1} - {x}_{0} )}{a ( {b}_{0} {x}_{0} + {c}_{0} )} - 1 \vert = \\ = \vert \frac{( \frac{1}{2} {b}_{0} ( {x}_{1} + {x}_{0} ) + {c}_{0} ) ( {x}_{1} - {x}_{0} )}{a ( {b}_{0} {x}_{0} + {c}_{0} )} - 1 \vert = \\ \vert \frac{( \frac{1}{2} {b}_{0} ( {x}_{1} + {x}_{0} ) + {c}_{0} ) a}{a ( {b}_{0} {x}_{0} + {c}_{0} )} - 1 \vert = \\ = \vert \frac{\frac{1}{2} {b}_{0} ( {x}_{1} + {x}_{0} ) + {c}_{0}}{{b}_{0} {x}_{0} + {c}_{0}} - 1 \vert = \\ \vert \frac{\frac{1}{2} {b}_{0} {x}_{1} + \frac{1}{2} {b}_{0} {x}_{0} + {c}_{0} - ( {b}_{0} {x}_{0} + {c}_{0} )}{{b}_{0} {x}_{0} + {c}_{0}} \vert = \\ = \vert \frac{\frac{1}{2} {b}_{0} {x}_{1} - \frac{1}{2} {b}_{0} {x}_{0}}{{b}_{0} {x}_{0} + {c}_{0}} \vert = \vert \frac{\frac{1}{2} {b}_{0} ( {x}_{1} - {x}_{0} )}{{b}_{0} {x}_{0} + {c}_{0}} \vert = \vert \frac{\frac{1}{2} {b}_{0} a}{{b}_{0} {x}_{0} + {c}_{0}} \vert\end{matrix}$$

According to an aspect, if p₀ is the spot price before the trade, the price impact may be determined according to the following example equation:

$$Price Impact = \frac{\vert a \vert {b}_{0}}{2 {p}_{0}}$$

### Example MEV Formula

In an embodiment, an example measure of MEV may be defined with reference to the concept of a sandwich attack. For instance, when a non-malicious trader submits a transaction of quantity Q, an attacker may then be able to “sandwich” either side of this transaction with a pair of buy/sell transactions, each of size S. If the current outstanding supply of token is xₙ at the time the attack is initiated, then the profit the attacker attains may be given by the following example equation for MEV(S, Q):

$$MEV ( S , Q ) = \frac{SV}{2} \cdot ( \frac{{x}_{n} + Q}{C + {x}_{n} + Q + S} + \frac{Q}{C + {x}_{n} + S} - \frac{{x}_{n}}{C + {x}_{n}} )$$

It should be noted that, according to an aspect, given a fixed non-malicious transaction quantity Q, the size of MEV(S, Q) for an example embodiment is bounded. This is unlike existing markets, such as Uniswap V2, where MEV(S, Q) may go to infinity as S approaches infinity.

Further, it should be noted that, in an implementation, for a given Q value, S may have a “critical” value S_{crit}, above which the MEV will be negative. It may be shown that this value S_{crit} satisfies the following example equation:

$$\frac{{x}_{n} + Q}{( C + {x}_{n} + Q ) + {S}_{crit}} + \frac{Q}{( C + {x}_{n} ) + {S}_{crit}} = \frac{{x}_{n}}{C + {x}_{n}}$$

1. A computational system comprising:
a decentralized consensus-secured ledger computer network having multiple computing nodes configured to maintain a consensus-secured ledger of a distributed deterministic state machine;
at least one node of the multiple computing nodes configured to execute a decentralized adaptive state-transition bonding curve smart contract system;
the decentralized adaptive state-transition bonding curve smart contract system configured to maintain a cumulative state variable of respective cryptographic asset quantities within the distributed deterministic state machine;
wherein the decentralized adaptive state-transition bonding curve smart contract system executes a deterministic adaptive state-transition bonding curve model based on the cumulative quantity state variable having a slope parameter and an intercept parameter;
determining the slope parameter as a deterministic inverse function of the cumulative quantity state variable and a concentration parameter;
computing a state-transition delta by evaluating a quadratic accumulation function before and after the modification;
updating the cumulative quantity state variable of the first cryptographic asset;
recalculating the slope parameter based on the updated cumulative quantity state variable;
recalculating the intercept parameter such that the adaptive linear evaluation function remains continuous at the updated cumulative quantity state variable; and
updating an aggregate stored value according to the computed state-transition delta.

2. The computational system of claim 1, wherein the decentralized adaptive state-transition bonding curve smart contract system executes a deterministic adaptive state-transition bonding curve model in response to an authenticated instruction from the distributed deterministic state machine specifying a modification to a cumulative quantity state variable of a first cryptographic asset.

3. The computational system of claim 1, wherein the decentralized adaptive state-transition bonding curve smart contract system is configured to iteratively update the cumulative state variable.

4. The computational system of claim 1, wherein the cumulative quantity variable is a computational control index of the deterministic adaptive state-transition bonding curve model.

5. The computational system of claim 1, wherein each cumulative quantity state variable is configured with a slope parameter.

6. The computational system of claim 1, wherein the deterministic adaptive state-transition bonding curve model maintains the cumulative quantity state variable; and
wherein the valid value of the cumulative quantity state variable includes multiple iterations including: an initial value, an intermediate value, and updated value.

7. The computational system of claim 1, wherein the deterministic adaptive state-transition bonding curve model includes a sensitivity model, a sensitivity parameter, and a limit parameter, and wherein the decentralized adaptive state-transition bonding curve smart contract system is configured to transform the identified deterministic adaptive state-transition bonding curve model by:
transforming the adaptive state reserve into an adapted adaptive state reserve based on the first quantity;
determining an adapted value of the sensitivity parameter via the sensitivity model based on a first asset size of the adapted adaptive state reserve; and
determining an adapted value of the limit parameter based on the first asset size, the adapted value of the sensitivity parameter, a prior value of the sensitivity parameter, and a prior value of the limit parameter.

8. The computational system of claim 7, wherein the sensitivity model has a vector field parameter and a control parameter, and wherein the decentralized adaptive state-transition bonding curve smart contract system is further configured to:
receive an indication of a multiplier value, a penalty value, a target asset quantity, and a target minimum value;
determine a value of the vector field parameter based on the multiplier value, the penalty value, the target asset quantity, and the target minimum value; and
determine a value of the control parameter based on the multiplier value, the penalty value, the target asset quantity, and the target minimum value.

9. The computational system of claim 1, wherein the decentralized adaptive state-transition bonding curve smart contract system is further configured to:
determine a value of a transaction based on the first quantity, a first asset size of the adaptive state reserve, and the determined computational value.

10. The computational system of claim 9, wherein the transaction is a first transaction, and wherein the decentralized adaptive state-transition bonding curve smart contract system is further configured to:
receive an indication of a second transaction for a second quantity of the second cryptographic asset; and
determine a value of the second transaction, via the adapted deterministic adaptive state-transition bonding curve model, based on the second quantity and a second asset size of the adaptive state reserve.

11. The computational system of claim 1, wherein the slope parameter equals a constant numerator divided by the sum of the cumulative quantity state variable and the concentration parameter.

12. The computational system of claim 1, wherein the slope parameter decreases monotonically as the cumulative quantity increases.

13. The computational system of claim 1, wherein the quadratic accumulation function equals one-half multiplied by the slope parameter multiplied by the square of the cumulative quantity plus the intercept parameter multiplied by the cumulative quantity.

14. The computational system of claim 1, wherein recalculating the intercept parameter includes subtracting one-half of a change in slope multiplied by the updated cumulative quantity from a prior intercept parameter.

15. The computational system of claim 1, further comprising:
wherein the cumulative quantity state variable is constrained to remain above a strictly positive minimum threshold; and
wherein the slope parameter is path independent such that any identical cumulative quantity value yields an identical slope parameter regardless of prior state transitions.

16. (canceled)

17. The computational system of claim 1, wherein repeated departures from and returns to a prior cumulative quantity value result in a strictly greater aggregate stored value.

18. The computational system of claim 1, wherein the strictly greater aggregate stored value arises from preservation of accumulated quadratic contributions across cyclic quantity paths.

19. The computational system of claim 1, wherein partitioning a requested modification into multiple sequential smaller modifications produces progressively reduced response sensitivity due to recalculation of the slope parameter after each sequential modification.

20. The computational system of claim 1, wherein as a number of partitions approaches infinity, resulting output converges to a continuous limiting curve comprising:
a rational component based on a ratio of the cumulative quantity to the cumulative quantity plus the concentration parameter; and
a logarithmic component based on a ratio of updated and prior cumulative quantities adjusted by the concentration parameter.

21-26. (canceled)

27. The computational system of claim 1, wherein the decentralized adaptive state-transition bonding curve smart contract system is further configured to:
detect a malicious transaction for a malicious transaction quantity of the first cryptographic asset; and
determine an attack value for the malicious transaction via the identified deterministic adaptive state-transition bonding curve model based on the first quantity and the malicious transaction quantity.

28-36. (canceled)
